(19) United States
(12) Patent Application Publication
(10) Pub. No.: US 2025/0298346 A1
(43) Pub. Date: Sep. 25, 2025

(54) IMAGE FORMING APPARATUS

(71) Applicants: Taira OTSUKA, Kanagawa (JP); Akihiro KAWASAKI, Kanagawa (JP); Yutaro KAKU, Kanagawa (JP); Shuichi NAKAGAWA, Kanagawa (JP); Shintaro YAMADA, Kanagawa (JP); Yasuhide MATSUNO, Kanagawa (JP); Hiroaki KATO, Kanagawa (JP)

(72) Inventors: Taira OTSUKA, Kanagawa (JP); Akihiro KAWASAKI, Kanagawa (JP); Yutaro KAKU, Kanagawa (JP); Shuichi NAKAGAWA, Kanagawa (JP); Shintaro YAMADA, Kanagawa (JP); Yasuhide MATSUNO, Kanagawa (JP); Hiroaki KATO, Kanagawa (JP)

(73) Assignee: Ricoh Company, Ltd., Tokyo (JP)

(21) Appl. No.: 19/067,241

(22) Filed: Feb. 28, 2025

(30) Foreign Application Priority Data
Mar. 19, 2024 (JP) 2024-043794

(51) Int. Cl. G03G 15/16; G03G 21/10

(52) U.S. Cl. CPC G03G 15/1675; G03G 21/10

(57) ABSTRACT

An image forming apparatus includes a bearer, a charger charging the bearer at a charging position, a developing device forming an image at a developing position, a transferor transferring the image onto a transfer medium in a transfer period, a power source to flow a first current during the transfer period and a second current during a non-transfer period, and circuitry. The circuitry controls the power source to set a value of the second current to at least one of zero or a value having the same polarity as the first current and an absolute value different from that of the first current and set a charge amount of toner on the bearer between the charging position and the developing position to be from −30 μC/g to −25 μC/g.

### CROSS-REFERENCE TO RELATED APPLICATION

This patent application is based on and claims priority pursuant to 35 U.S.C. § 119 (a) to Japanese Patent Application No. 2024-043794, filed on Mar. 19, 2024, in the Japan Patent Office, the entire disclosure of which is hereby incorporated by reference herein.

### BACKGROUND

### Technical Field

The present disclosure relates to an image forming apparatus.

### Related Art

An electrophotographic image forming apparatus includes a charger such as a charging roller to charge an image bearer such as a photoconductor, a developing device to supply toner to the photoconductor, and a transfer device to transfer the toner on the photoconductor to a recording medium or an intermediate transferor.

In addition, the electrographic image forming apparatus includes a cleaner such as a cleaning blade to clean the toner adhered to the photoconductor. In recent years, a so-called cleanerless system has been proposed to downsize the image forming apparatus. The image forming apparatus employing the cleanerless system, which is referred to as a cleanerless image forming apparatus, does not include the cleaner dedicated to cleaning the photoconductor.

In the cleanerless image forming apparatus, the developing device collects transfer residual toner remaining on the photoconductor after the toner is transferred. Since the developing device collects and reuses the transfer residual toner, the cleanerless image forming apparatus can reduce waste toner. As a result, the cleanerless system can simplify user maintenance and does not require a waste toner container, which reduces waste.

The cleanerless image forming apparatus collects the toner, for example, as follows. Increasing a voltage applied to the charger, which is referred to as a charging bias, increases a background potential difference between the potential of the charger and the potential of the photoconductor to collect the transfer residual toner. The background potential difference between the charger and the photoconductor moves the toner adhered to the charger toward the photoconductor, and the developing device collects the toner.

### SUMMARY

The present disclosure described herein provides the image forming apparatus including an image bearer, a charger, a developing device, a transferor, a transfer power source, and circuitry. The image bearer is rotatable in a rotation direction. The charger faces the image bearer at a charging position and charges the image bearer at the charging position. The developing device includes a developing roller. The developing roller faces the image bearer at a developing position to supply toner to the image bearer and form a toner image on the image bearer with the toner at the developing position. The transferor transfers the toner image onto a transfer medium in a transfer period. The transfer power source applies voltages to the transferor to flow a first transfer current to the transferor during the transfer period and flow a second transfer current different from the first transfer current to the transferor during a non-transfer period when the transferor does not transfer the toner image to the transfer medium. The circuitry is configured to control the transfer power source to set a value of the second transfer current to at least one of zero or a value having the same polarity as the first transfer current and an absolute value different from an absolute value of the first transfer current and control a charge amount of a transfer residual toner during the non-transfer period, remaining on the image bearer downstream of the charging position and upstream of the developing position in the rotation direction after the toner is transferred to the transfer medium, to be −30 uC/g or more and −25 uC/g or less.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of an image forming apparatus;

FIG. 2A is a block diagram of a hardware configuration of a controller and power sources;

FIG. 2B is a block diagram of a hardware configuration regarding the controller of FIG. 2A;

FIG. 3 is a schematic diagram illustrating a basic configuration of a cleanerless image forming apparatus;

FIG. 4 is a schematic diagram illustrating processes during printing in the cleanerless image forming apparatus of FIG. 3.

FIG. 5A is a schematic diagram illustrating shutdown processes in the cleanerless image forming apparatus of FIG. 3;

FIG. 5B is a schematic diagram illustrating shutdown processes subsequent to the processes of FIG. 5A;

FIG. 6A is a schematic diagram illustrating a charging process, an exposure process, a developing process, and a transfer process;

FIG. 6B is a schematic diagram illustrating collection of transfer residual toner by a developing device;

FIG. 7 is a graph illustrating an example of a relation of a transfer current, a charge amount of toner after the toner passes through a charging position, and occurrence of retransfer;

FIG. 8 is a view of an image chart used for evaluations of experiments;

FIG. 9 is an example of a timing chart;

FIG. 10 is a table of evaluation results of retransfer;

FIG. 11 is another example of a timing chart;

FIGS. 12A and 12B are an example of tables used to control the cleanerless image forming apparatus of FIG. 3;

FIG. 13 is another schematic diagram of a cleanerless image forming apparatus; and

FIG. 14 is an yet another schematic diagram of a cleanerless image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to the drawings. Like reference signs are assigned to identical or equivalent components and a description of those components may be simplified or omitted.

A description is provided of an image forming apparatus according to the present disclosure with reference to the drawings. It is to be noted that the present disclosure is not to be considered limited to the following embodiments but can be changed within the range that can be conceived of by those skilled in the art, such as other embodiments, additions, modifications, deletions, and the scope of the present disclosure encompasses any aspect, as long as the aspect achieves the operation and advantageous effect of the present disclosure.

A description is given below of an embodiment.

The image forming apparatus according to the present embodiment includes an image bearer, a charger, a developing device, a transferor, a transfer power source, and circuitry. The image bearer is rotatable. The charger charges the image bearer at a charging position at which the charger faces the image bearer. The developing device includes a developing roller to supply toner to the image bearer and forms a toner image on the image bearer at a developing position at which the image bearer faces the developing roller. The transferor transfers the toner image onto a transfer medium in a transfer period. The transfer power source applies voltages to the transferor to cause a first transfer current to flow through the transferor during the transfer period and cause a second transfer current to flow through the transferor during a non-transfer period in which the transferor does not transfer the toner image to the transfer medium. The circuitry is configured to control the transfer power source to set a value of the second transfer current to at least one of zero or a value having the same polarity as the first transfer current and having an absolute value different from an absolute value of the first transfer current and set a charge amount of a transfer residual toner during the non-transfer period on the image bearer downstream of the charging position and upstream of the developing position in a rotation direction of the image bearer to be −30 μC/g or more and −25 μC/g or less.

The image forming apparatus may be referred to as an electrophotographic apparatus or a printer. The image forming apparatus of the present disclosure may be a cleanerless image forming apparatus. The cleanerless system may be referred to as a cleanerless image forming system.

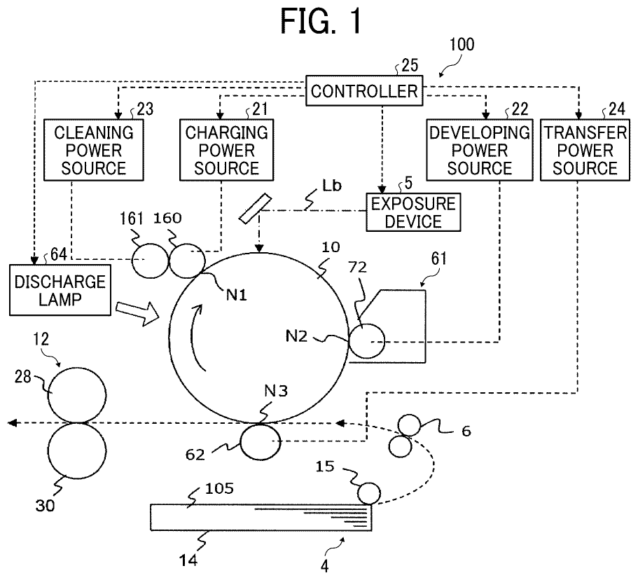

With reference to the drawings, a cleanerless image forming apparatus 100 is described below. The image forming apparatus 100 includes a charging roller as a charger, a developing device including a developing roller, and a photoconductor drum as a photoconductor that is an example of an image bearer. The image forming apparatus 100 uses a sheet or a recording medium as a transfer medium but may use an intermediate transferor such as an intermediate transfer belt as the transfer medium. FIG. 1 is a schematic diagram of the image forming apparatus 100. As illustrated in FIG. 1, the image forming apparatus 100 includes a sheet feeder 4, a registration roller pair 6, a photoconductor drum 10 as the image bearer, a transfer roller 62, and a fixing device 12.

The image forming apparatus 100 further includes a charging power source 21, a developing power source 22, a cleaning power source 23, a transfer power source 24, which supply bias voltages for forming an image and a controller 25 that is circuitry to control the outputs of these power sources.

The charging power source 21 applies a voltage to a charging roller 160 as the charger, and the voltage applied to the charging roller 160 may be referred to as a charging bias voltage. The developing power source 22 applies a voltage to a developing roller 72 in a developing device 61, and the voltage applied to the developing roller 72 may be referred to as a developing bias voltage. The transfer power source 24 applies a voltage to a transfer roller 62 as a transferor, and the voltage applied to the transfer roller 62 may be referred to as a transfer bias voltage.

The sheet feeder 4 includes a sheet tray 14 and a feed roller 15. The sheet tray 14 accommodates a stack of sheets 105. The feed roller 15 sequentially separates and feeds an uppermost sheet 105 from the stack of sheets 105 accommodated in the sheet tray 14. The sheet is an example of the transfer medium and may be referred to as a recording medium, a recording material, or a medium.

The registration roller pair 6 temporarily stops the uppermost sheet 105 fed by the feed roller 15 to correct the skew of the sheet 105. After correcting the skew of the sheet 105, the registration roller pair 6 sends the sheet 105 to a transfer portion N3, which is also referred to as a transfer position, at a timing synchronizing rotation of the photoconductor drum 10, that is, the timing at which a leading edge of a toner image formed on the photoconductor drum 10 meets a certain position of a leading edge of the sheet S in a sheet conveyance direction.

Around the photoconductor drum 10, the image forming apparatus includes the charging roller 160 as the charger, the developing device 61 including the developing roller 72, and the transfer roller 62 in an order indicated by an arrow in FIG. 1.

The charging roller 160 and the developing roller 72 are in contact with the photoconductor drum 10. A collection brush 161 (which may be referred to as a brush roller, a cleaning brush, or a cleaner) is in contact with the charging roller 160. The collection brush 161 is an example of a collector.

The charging roller 160 may be in contact with the photoconductor drum 10 or may not be in contact with the photoconductor drum 10. Preferably, the charging roller 160 is in contact with the photoconductor drum 10. The charging roller 160 in contact with the photoconductor drum 10 stably performs a discharge process (in other words, pre-charging discharge).

The exposure device 5 irradiates and scans the surface of the photoconductor drum 10 between the charging roller 160 and the developing device 61 with an exposure light Lb.

After the photoconductor drum 10 starts rotating, the charging power source 21 applies the charging bias voltage to the charging roller 160, and the charging roller 160 uniformly charges the surface of the photoconductor drum 10 at a charging region N1 (which may be referred to as a charging position). Based on image data, the controller 25 controls the exposure device 5 to irradiate the surface of the photoconductor drum 10 with the exposure light Lb to reduce an electric potential on the surface of the photoconductor drum 10 corresponding to an image to be formed to form an electrostatic latent image. The rotation of the photoconductor drum 10 moves the electrostatic latent image to a developing region N2 (which may be referred to as a developing position). The developing power source 22 applies the developing bias voltage to the developing roller 72 in the developing device 61.

In the developing region N2, negatively charged toner held on the developing roller 72 is supplied from the developing roller 72 to the photoconductor drum 10 in accordance with the potential difference between the potential of the exposed portion and the developing bias voltage to form a toner image on the photoconductor drum 10. The toner image formed on the photoconductor drum 10 moves to a transfer region N3 at a predetermined timing. The transfer power source 24 applies the transfer bias voltage to the transfer roller 62 to transfer the toner image on the photoconductor drum 10 to the sheet 105 that has entered the transfer region N3.

The controller 25 determines the transfer bias voltage, which may be referred to as a transfer bias. The controller 25 adjusts the transfer bias voltage using information from, for example, a sensor, a timer, and a driver.

After the transfer roller 62 transfers the toner image from the photoconductor drum 10 onto the sheet 105, the sheet 105 bearing the toner image is conveyed toward the fixing device 12. A fixing roller 28 and a pressure roller 30 in the fixing device 12 fix the toner image onto the sheet 105. After that, the sheet 105 is ejected and stacked on an output tray. The transfer residual toner remaining on the photoconductor drum 10 without being transferred to the sheet 105 in the transfer region N3 reaches the charging region N1 with the rotation of the photoconductor drum 10. In the charging region N1, the transfer residual toner is charged to a negative polarity by a discharge in a small gap between the photoconductor drum 10 and the charging roller 160 to which the charging bias voltage is applied and is returned to the developing region N2.

In the developing region N2, the transfer residual toner is moved onto the developing roller 72 by a potential difference between the developing bias voltage and a potential of a non-exposure portion that is not exposed by the exposure device 5 and is collected into the developing device 61.

In the charging region N1, it is difficult to completely charge the transfer residual toner to the negative polarity, and the toner having the positive polarity adheres to the charging roller 160. Accordingly, it is preferable to use the collection brush 161 for scraping off the contamination of the charging roller 160. The cleaning power source 23 applies a cleaning bias voltage to the collection brush 161. Mechanical scraping and the potential difference between the collection brush 161 and the charging roller 160 cleans the toner having the positive polarity and adhering to the charging roller 160. Using the collection brush 161 can clean the charging roller 160 more.

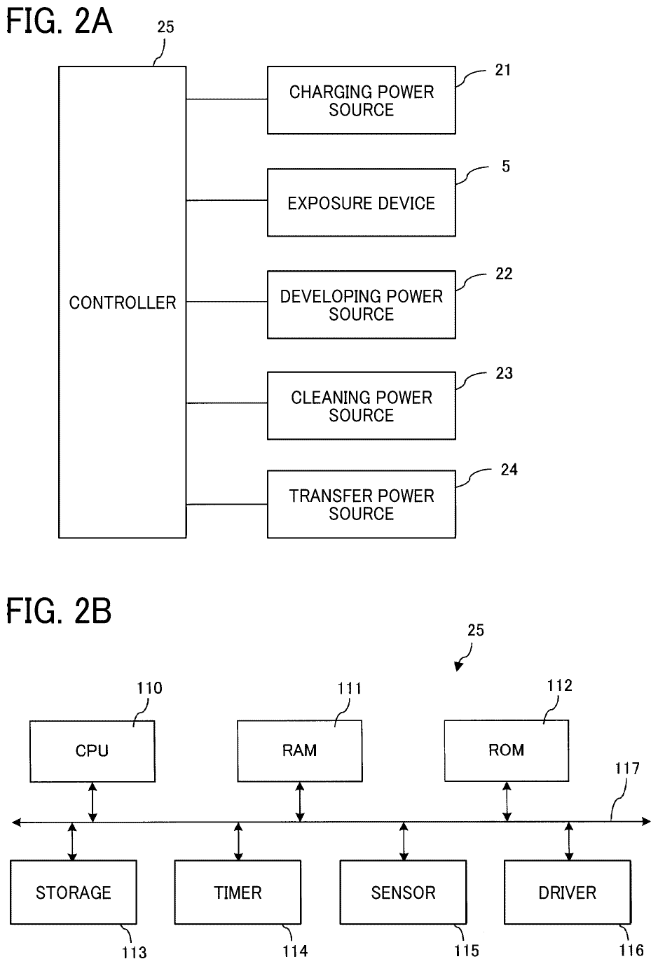

FIG. 2A is a block diagram of a hardware configuration of the controller 25 and power sources. The controller 25 includes a central processing unit (CPU) as a central element to perform arithmetic processing and memories such as a read-only memory (ROM) and a random-access memory (RAM). The RAM stores detection results of sensors and calculation results, and the ROM stores control programs and data tables obtained in advance. The controller 25 controls, for example, the charging power source 21, the developing power source 22, the cleaning power source 23, the transfer power source 24, and the exposure device 5. The controller 25 controls ON and OFF of the output of the power sources and output values of the power sources. The controller 25 controls a discharge lamp 64 as a discharger to eliminate charge from the photoconductor drum 10 before the pre-charging discharge.

FIG. 2B is a block diagram of a hardware configuration of the controller 25.

In the controller 25, a central processing unit (CPU) 110, a random-access memory (RAM) 111, a read-only memory (ROM) 112, and a storage 113 are connected to each other via a bus 117.

The CPU 110 is an arithmetic device and controls the overall operation of the image forming apparatus 100. The RAM 111 is a volatile storage medium that allows data to be read and written at high speed. When the CPU 110 processes data, the RAM 111 is used as a working area of the CPU 110. The ROM 112 is a read-only non-volatile storage medium and stores programs such as firmware.

The storage 113 is a non-volatile storage medium that allows data to be read and written, and that stores, for example, an operating system (OS), various control programs, and application programs. The storage 113 is, for example, a solid-state drive (SSD) or a hard disk drive (HDD).

A timer 114, a sensor 115, and a driver 116 are connected to the CPU 110 via the bus 117. The timer 114 is hardware that counts various times such as a driving time for driving the driver. However, the present disclosure is not limited to this, and the timer 114 may be software. The sensor 115 is, for example, a temperature and humidity sensor, and is used to obtain an absolute humidity inside or outside the image forming apparatus. The driver 116 is, for example, a driving source for driving the developing roller and includes, for example, a motor or a clutch.

The controller 25 can obtain the absolute humidity inside or outside the image forming apparatus, an integrated driven amount of the developing roller, and an integrated number of times of a transfer operation. To obtain the integrated driven amount of the developing roller, the controller 25 calculates an integration of a driven amount of the developing roller from the start to the end of the drive of the developing roller, using the CPU 110, the timer 114, the sensor 115, and the driver 116. To obtain the integrated number of times of the transfer operation, the controller 25 calculates an integration of a number of times of the transfer operation, using the CPU 110, the timer 114, the sensor 115, and the driver 116. The integrated driven amount of the developing roller may be referred to as a travel distance. The integrated number of times of transfer may be referred to as a number of sheets passed and can be counted by the controller 25. These values obtained by the controller 25 are used for, for example, adjustment of the transfer bias.

In the image forming apparatus of the present embodiment, the developing device collects the transfer residual toner remaining on the image bearer. The image forming apparatus of the present embodiment is configured not to use a cleaner such as a cleaning blade to clean the image bearer which is also referred to as an electrostatic latent image bearer or a photoconductor. The above-described image forming apparatus has an advantage of downsizing the image forming apparatus.

In the following description, the cleanerless system is described as a system not including the cleaner cleaning the image bearer. The cleanerless system may include a cleaner cleaning the charger or a cleaner cleaning the intermediate transfer belt. In addition, the cleanerless system may include a system that temporarily collects the transfer residual toner on the image bearer.

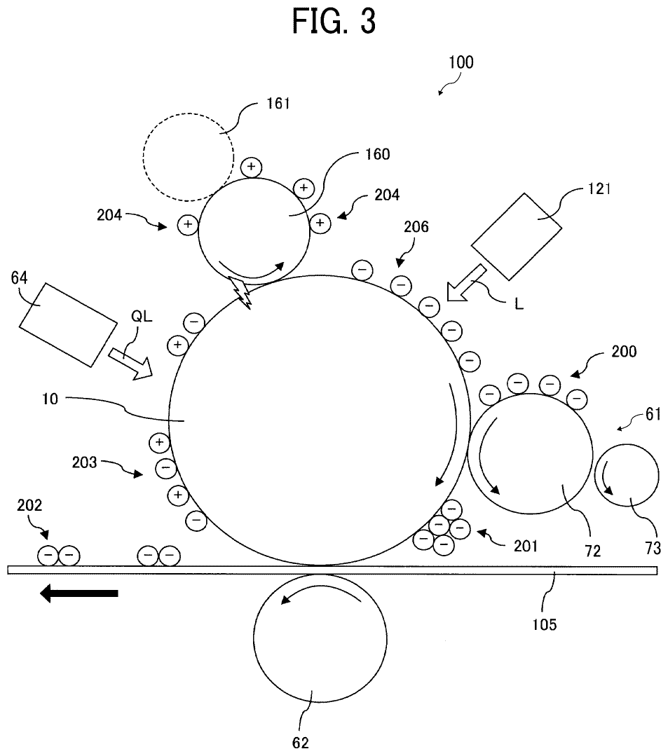

The basic configuration and operation of the cleanerless image forming apparatus is described with reference to FIG. 3. FIG. 3 is a schematic diagram illustrating an example of an image forming process. The image forming apparatus in FIG. 3 includes the charging roller as the charger. In the following description, the charging roller is described as an example of the charger.

The charging roller 160 uniformly charges the photoconductor drum 10 as the image bearer. The charging roller 160 in the present embodiment is disposed to be in contact with the photoconductor drum 10, and, for example, a direct current (DC) voltage is applied to charge the photoconductor drum 10. In this embodiment, a contact type DC charging system is employed. The exposure device 5 exposes the photoconductor drum 10 to exposure light L to form the electrostatic latent image on the photoconductor drum 10. The exposure device 5 is not particularly limited. For example, a light-emitting diode (LED) is used.

The developing device 61 includes the developing roller 72 that is one example of a developer bearer. The developing power source applies the developing bias voltage to the developing roller 72, and the developing roller 72 supplies toner 200 to the photoconductor drum 10. As a result, the toner image, which is also referred to as a visible image is formed on the photoconductor drum 10. The developing device 61 may include, for example, a stirring roller 73 to stir the toner in the developing device 61. The rotation direction of the stirring roller 73 can be appropriately selected, and the stirring roller 73 may be in contact with the developing roller 72 or may not be in contact with the developing roller 72. The transfer roller 62 transfers the toner image on the photoconductor drum 10 onto the sheet 105. The discharge lamp 64 eliminates the potential of the photoconductor drum 10. For example, the discharge lamp 64 irradiates the photoconductor drum 10 with charge eliminating light QL to eliminate the charge from the photoconductor drum 10.

The above configuration is a basic configuration of the cleanerless image forming apparatus. The cleanerless image forming apparatus does not include a cleaner such as the cleaning blade to clean the photoconductor drum 10 after a transfer process.

In the example illustrated in FIG. 3, the developing power source applies −300 V to the developing roller 72, and the charging power source applies −1100 V to the charging roller 160. After the charge is eliminated from the photoconductor drum 10, the surface potential of the photoconductor drum 10 is, for example, about −50 V. After the charging roller charges the surface of the photoconductor drum 10, the surface potential of the photoconductor drum 10 is, for example, about −500 V. The image forming apparatus of the present embodiment may include the collection brush 161 as the collector that collects the toner on the charging roller 160.

The following describes an example of the flow of the toner in the example illustrated in FIG. 3. For the sake of explanation, the reference numerals of the toners in FIG. 3 are changed depending on the positions and states of the toners. The developing roller 72 bears the toner 200, and the toner 200 borne by the developing roller 72 is supplied to the photoconductor drum 10. The toner supplied to the photoconductor drum 10 becomes toner 201 and forms the toner image as the visible image in accordance with the electrostatic latent image. The toner 201 on the photoconductor drum 10 is transferred onto the sheet 105. Toner 202 transferred to the sheet 105 is fixed to the sheet 105 in a later process.

The toner that has not been transferred in the transfer process remains on the photoconductor drum 10 as transfer residual toner 203. After a process to eliminate the charge from the photoconductor drum 10, the transfer residual toner 203 adheres to the charging roller 160 at a contact portion at which the photoconductor drum 10 contacts the charging roller 160 and in the vicinity of the contact portion. A part of the transfer residual toner 203 does not adhere to the charging roller 160 and is referred to as toner 206. The toner 206 remains on the photoconductor drum 10. The developing roller 72 collects the toner 206.

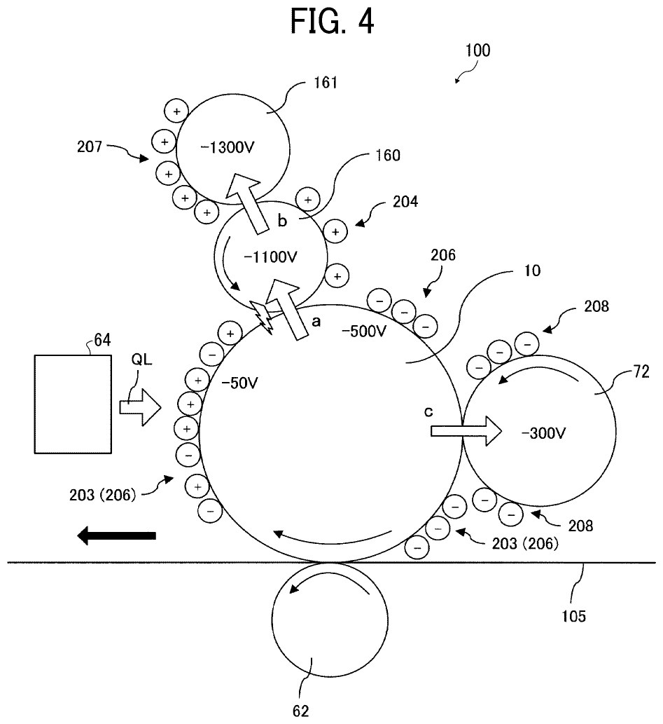

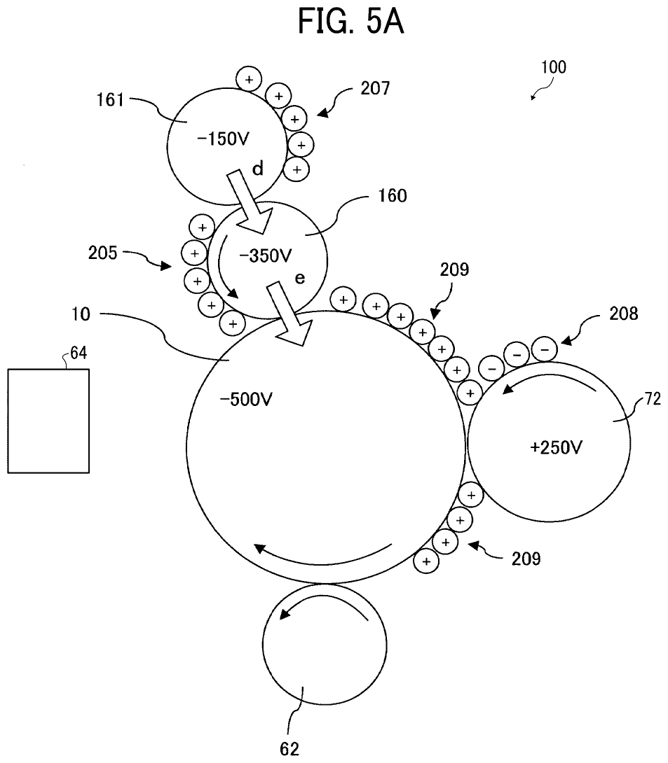

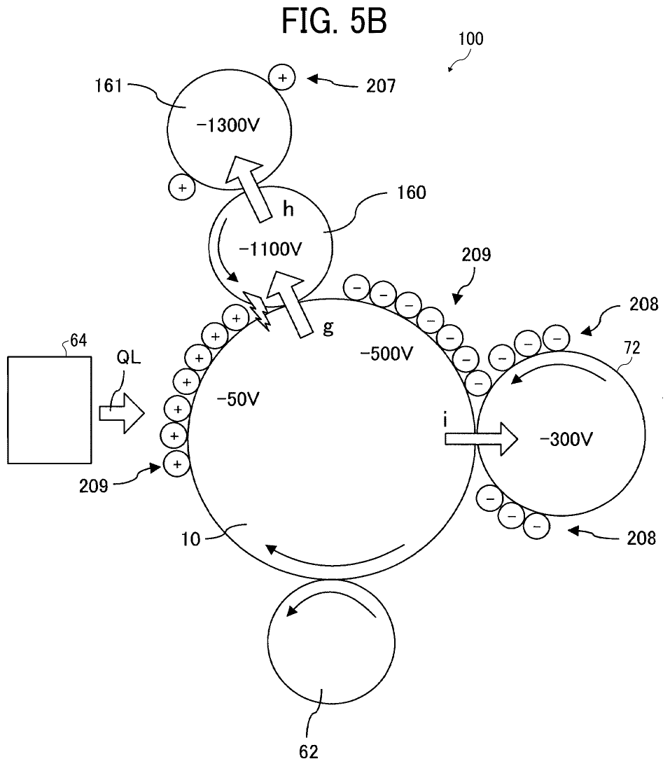

The following describes an example of a method to collect the transfer residual toner in the cleanerless image forming apparatus with reference to FIGS. 4, 5A and 5B.

FIG. 4 is a schematic diagram illustrating processes during printing in the cleanerless image forming apparatus of FIG. 3. The term “during printing” means that the image forming apparatus operates. “During printing,” the image forming apparatus performs not only a process of transferring toner to the sheet but also a process of preparing for the transfer of toner to the sheet (an exposure process and a developing process). FIG. 4 is a diagram to illustrate a process after the toner image is transferred to the sheet and before the next toner image is transferred to the next sheet.

As described with reference to FIG. 3, the toner that has not been transferred in the transfer process remains on the photoconductor drum 10 as the transfer residual toner 203. FIG. 4 illustrates the transfer residual toner 203 remaining on the photoconductor drum 10 downstream of the transfer roller 62 in the rotation direction of the photoconductor drum 10. After the toner image is transferred to the sheet 105, the discharge lamp 64 eliminates the charge on the surface of the photoconductor drum 10. As a result, the potential difference between the charging roller 160 and the photoconductor drum 10 increases, and discharge occurs between the charging roller 160 and the photoconductor drum 10 before the charging roller 160 charges the photoconductor drum 10, which is referred to as the pre-charging discharge. In FIG. 4, the discharge is schematically illustrated.

The pre-charging discharge negatively charges the transfer residual toner 203.

As a result, the pre-charging discharge generates negatively charged toner and minute positively charged toner in the transfer residual toner 203. The minute positively charged toner of the transfer residual toner 203 adheres to the charging roller 160 at the position at which the charging roller 160 contacts the photoconductor drum 10 (or in the vicinity of the position). The toner adhering to the charging roller 160 is illustrated as toner 204 in FIG. 4.

A white arrow a in FIG. 2 schematically indicates that the transfer residual toner 203 on the photoconductor drum 10 adheres to the charging roller 160. In other words, the transfer residual toner 203 on the photoconductor drum 10 moves to the charging roller 160.

The image forming apparatus of the present embodiment includes the collection brush 161 that collects the toner adhering to the charging roller 160. The collection brush 161 collects the positively charged toner 204 adhering to the charging roller 160. A white arrow b in FIG. 2 schematically indicates that the collection brush 161 collects the toner 204 on the charging roller 160. In other words, the toner 204 on the charging roller 160 moves to the collection brush 161. A collection bias is applied to the collection brush 161. The value of the collection bias is not particularly limited and can be appropriately selected.

The negatively charged toner of the transfer residual toner 203 on the photoconductor drum 10 does not adhere to the charging roller 160 and remains on the photoconductor drum 10. This toner is illustrated as the toner 206 in FIG. 4. Note that the transfer residual toner includes the toner 203 and the toner 206.

The toner 206 remaining on the photoconductor drum 10 is collected by the developing roller 72. The toner collected by the developing roller 72 is illustrated as toner 208 in FIG. 4. In other words, the toner 206 remaining on the photoconductor drum 10 moves to the developing roller 72. The toner 206 passing between the photoconductor drum 10 and the developing roller 72 moves to the developing roller 72 due to a potential difference between the photoconductor drum 10 and the developing roller 72. A white arrow c in FIG. 4 schematically indicates that the toner 206 on the photoconductor drum 10 is collected by the developing roller 72.

In order to collect the toner by the developing roller 72 as described above, for example, a method of adjusting the potential of each member is used. One example of the potentials of members is as follows. The surface potential of the photoconductor drum 10 after the charge is eliminated from the photoconductor drum 10 is −50 V, the potential of the charging roller 160 is −1100 V, the potential of the collection brush 161 is −1300 V, the surface potential of the photoconductor drum 10 after the charging roller charges the photoconductor drum 10 is −500 V, and the potential of the developing roller 72 is −300V. In FIG. 4, the above-described potentials are illustrated, but the potentials are not limited to these.

The image forming apparatus preferably includes the collection brush 161 but does not always need the collection brush 161. In the image forming apparatus not including the collector such as the collection brush 161 to collect the toner on the charging roller 160, it is preferable to adjust the potentials so as to reduce the toner moving to the charging roller 160.

The following describes an example of the movement of the toner and the toner collection during a shutdown process of the image forming apparatus with reference to FIGS. 5A and 5B. As described with reference to FIG. 4, the positively charged toner of the transfer residual toner 203 (and the toner 206) that the pre-charging discharge cannot negatively charge adheres to the charging roller 160 and is collected by the collection brush 161. Since this collection is repeated during printing, the positively charged toner is accumulated on the collection brush 161 and becomes toner 207.

During the shutdown process of the image forming apparatus, adjusting the potential difference between the collection brush 161 and the charging roller 160 moves the minute positively charged toner 207 to the charging roller 160. This is indicated by an arrow d in FIG. 5A.

Toner 205 moved to the charging roller 160 is moved to the photoconductor drum 10 by the potential difference between the charging roller 160 and the photoconductor drum 10. This is indicated by a white arrow e in FIG. 5A. The moved toner is illustrated as toner 209 in FIG. 5A. Specifically, during the shutdown process illustrated in FIG. 5A, the discharge lamp 64 is tuned off, and the negatively charged photoconductor drum 10 reaches the charging position. The controller controls the charging power source to reduce the absolute value of the voltage applied to the charging roller 160 to be smaller than the absolute value of the surface potential of the photoconductor drum 10, which forms the potential difference that moves the toner 205 from the charging roller 160 to the photoconductor drum 10.

The positively charged toner 209 on the photoconductor drum 10 is not collected by the developing roller 72 and passes through the developing roller 72 as it is. Further, the toner 209 passes through the transfer roller 62. As a result, the positively charged toner 209 exists on the photoconductor drum 10 during the shutdown process of the image forming apparatus.

In FIGS. 4, 5A and 5B, the above-described toners 203, 206 and 209 are illustrated on the photoconductor drum 10. All of these are considered as the transfer residual toner. After the transfer residual toner 203 is collected by the collection brush 161, the toner moves to the photoconductor drum 10 again as the toner 209. Such toner may be also included in the transfer residual toner.

In order to move the toner as in the example illustrated in FIG. 5A, for example, the potentials of members are adjusted. One example of the potentials of members is as follows. The potential of the collection brush 161 is −150 V, the potential of the charging roller 160 is −350 V, the surface potential of the photoconductor drum 10 is −500 V, and the potential of the developing roller 72 is +250 V. FIG. 5A illustrates the above-described potentials, but the potentials are not limited to this example.

The following describes how the toner on the photoconductor drum 10 is collected during the shutdown process with reference to FIG. 5B. FIG. 5B illustrates a situation subsequent to FIG. 5A. As illustrated in FIG. 5B, the discharge lamp 64 eliminates the charge on the photoconductor drum 10 at a predetermined timing. Eliminating the charge on the photoconductor drum 10 increases the potential difference between the charging roller 160 and the photoconductor drum 10 and causes the discharge between the charging roller 160 and the photoconductor drum 10. In FIG. 5B, the discharge is schematically illustrated. Note that the discharge lamp 64 eliminates the charge on the photoconductor drum 10 in order to collect the toner in FIG. 5B and does not eliminate the charge in order to form the toner image.

The above-described discharge negatively charges the toner 209. As described with reference to FIG. 4, some of the toner 209 is not negatively charged but remains positively charged. Such toner adheres to the charging roller 160 and is collected by the collection brush 161. Such toner moves as indicated by white arrows g and h in FIG. 5B.

The toner 209 negatively charged by the discharge remains on the photoconductor drum 10 without moving to the charging roller 160. The negatively charged toner 209 is collected by the developing roller 72 to which the developing bias voltage is applied and moves as indicated by a white arrow i in FIG. 5B. The toner collected by the developing roller 72 is illustrated as toner 208 in FIG. 5B.

In order to move the toner as in the example illustrated in FIG. 5B, for example, the potentials of members are adjusted. One example of the potentials of members is as follows. The potential of the collection brush 161 is −1300 V, the potential of the charging roller 160 is −1100 V, the surface potential of the photoconductor drum 10 after the discharge lamp eliminates the charge is −50 V, the surface potential of the photoconductor drum 10 after the charging roller charges the photoconductor drum 10 is −500 V, and the potential of the developing roller 72 is −300 V. FIG. 5B illustrates the above-described potentials, but the potentials are not limited to this example.

The discharge lamp 64 is an example of a charge eliminating device, which may be referred to as the discharger.

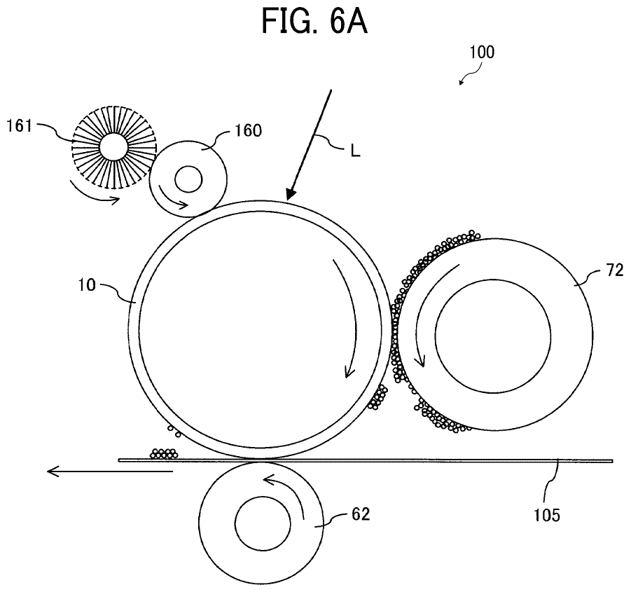

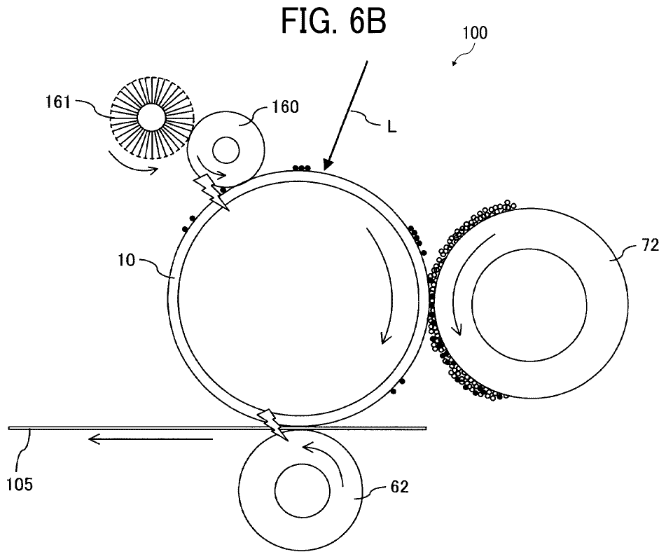

FIGS. 6A and 6B are other schematic diagrams to illustrate the image forming apparatus. Descriptions of the same items as those in the above examples is omitted.

FIG. 6A is a schematic diagram illustrating a charging process, an exposure process, a developing process, and a transfer process. As illustrated in FIG. 6A, the charging roller 160 charges the photoconductor drum 10. The photoconductor drum 10 is exposed to the exposure light L. The developing roller 72 supplies toner to the photoconductor drum 10. The transfer roller 62 transfers the toner onto the sheet 105.

FIG. 6B is a schematic diagram illustrating the collection of the transfer residual toner by the developing device.

The discharge is caused between the charging roller 160 and the photoconductor drum 10, which is referred to as the pre-charging discharge, to charge the transfer residual toner to a negative polarity (that is the typical polarity of the toner). The transfer residual toner charged to the negative polarity is collected by the developing roller 72 in accordance with a potential difference between the potential VB of the developing roller 72 and the potential VD of the photoconductor drum 10 that is referred to as a background potential difference. In other words, the background potential difference moves the toner typically charged from the photoconductor drum 10 to the developing roller 72, and the developing device collects the transfer residual toner. After the toner image is formed as described above, the cleanerless system uses the typical polarity of the charge of the transfer residual toner and the background potential difference to collect the transfer residual toner to the developing device.

Note that the potential VB of the developing roller 72 is determined by a voltage VB applied to the developing roller 72 by the developing power source, which is also referred to as a developing bias or the developing bias voltage. The potential VD of the photoconductor drum 10 is a surface potential of the photoconductor drum 10 after the photoconductor drum 10 passes through the charging roller 160.

The characteristic parts of the present embodiment are further described below.

The present inventors focused on the relationship between the photoconductor drum 10 and the transfer roller 62 and conducted intensive studies on the voltage applied to the transfer roller 62, which is referred to as the transfer bias and the transfer current flowing through the transfer roller 62. In the study, the inventors also focused on a transfer period during which the transferor transfers the toner image to the transfer medium and a non-transfer period during which the transferor does not transfer the toner image to the transfer medium. Further, the present inventors focused on the behavior of the transfer residual toner in the transfer period, the relationship between the transfer roller 62 and the photoconductor drum 10 in the non-transfer period, the pre-charging discharge, and the behavior of the transfer residual toner.

The present inventors found that adjusting the voltage applied to the transfer roller 62 to set an appropriate transfer current in the transfer period can minimize the amount of the transfer residual toner. In this regard, for example, the controller may perform control to set an appropriate transfer current based on the use status, and a detailed example of the control using the use status is described below.

In the non-transfer period, since there is no transfer medium between the transfer roller 62 and the photoconductor drum 10, the voltage applied to the transfer roller 62 affects the surface potential of the photoconductor drum 10. The surface potential of the photoconductor drum 10 after passing through the transfer position affects the discharge between the photoconductor drum 10 and the charging roller 160 and the charge amount of the transfer residual toner after passing through the charging position. Adjusting the transfer current in the non-transfer period to prevent the decrease in the charge amount of the toner having the typical charging polarity of the toner can reduce the amount of toner retransferred. It is expected that reducing the transfer current in the non-transfer period to be smaller than the transfer current in the transfer period can reduce the amount of toner retransferred.

A method of increasing the potential difference between the surface potential on the photoconductor drum and the voltage applied to the developing roller to obtain the background potential difference in which the developing roller can sufficiently collect the toner may be considered. However, for example, a use situation such as a high-humidity environment or long-term use reduces the charging ability of the toner. In such a case, the charge amount of the transfer residual toner before passing through the position of the charger becomes small, and therefore, the charge amount of the transfer residual toner after passing through the position of the charger may not be sufficiently increased. The insufficient charge amount of the transfer residual toner after passing through the position of the charger decreases the collection performance of the developing device even if the background potential difference is set to be high, and the retransfer occurs.

Alternatively, a method of switching between the transfer current flowing through the transferor in the transfer period, which may be referred to as a first transfer current, and the transfer current flowing through the transferor in the non-transfer period, which may be referred to as a second transfer current, may be also considered. The transfer current may be determined, for example, based on the amount of toner discharged from the charger, but the optimum transfer current varies depending on the use situation. Therefore, determining the transfer current based on the amount of discharged toner may cause the retransfer.

The present inventors further studied and found that the collection property of the developing device varies depending on the charge amount of the transfer residual toner that has passed through the charging position at which the charger charges the image bearer. Then, the controller in the present embodiment controls the transfer power source to switch the transfer current between the transfer period and the non-transfer period so as to set the charge amount of the transfer residual toner after passing through the charging position to a target value.

The above-described control enables the developing device to satisfactorily collect the transfer residual toner. In addition, the above-described control can reduce the retransferred toner. In a preferred embodiment of the present disclosure, performing control in accordance with the use situation can further increase the transfer residual toner collected by the developing device.

Key words in the present embodiment are defined as follows. The charging position is defined as a position at which the image bearer faces the charger. The developing position is defined as a position at which the developing roller faces the image bearer. The transfer current is defined as a current flowing through the transferor. The transfer period is defined as a period in which the transferor transfers the toner image to the transfer medium. The non-transfer period is defined as a period in which the transferor does not transfer the toner image to the transfer medium. The transfer current in the transfer period is referred to as the first transfer current. The transfer current in the non-transfer period is referred to as the second transfer current. The phrase “the toner after passing through the charging position” means that the toner on the image bearer passes through the charging position in the rotation direction of the image bearer and does not pass through the developing position, unless otherwise specified. In other words, the toner after passing through the charging position is on the image bearer downstream of the charging position and upstream of the developing position in the rotation direction of the image bearer.

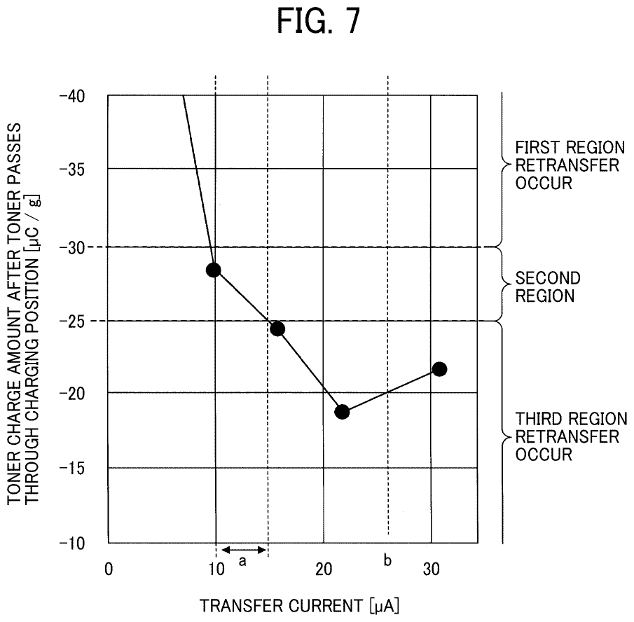

The features of the present embodiment are further described with reference to FIG. 7. FIG. 7 is a graph illustrating results of experiments investigating a relationship between the transfer current and the charge amount of the toner after passing through the charging position. In FIG. 7, the horizontal axis represents the transfer current (μA), and the vertical axis represents the charge amount (μC/g) of the toner after passing through the charging position. The experiments of FIG. 7 were performed under a high temperature and high humidity environment.

A suction device was used to measure the charge amount of the toner after passing through the charging position. In the experiment, the photoconductor drum 10 was stopped after the transfer residual toner on the photoconductor drum 10 in the image forming apparatus passes through the charging position. Subsequently, the photoconductor drum 10 was taken out from the image forming apparatus. The toner on the photoconductor drum 10 was sucked from the nozzle of a suction device by a pump. The suction device includes a Faraday cage including a filter inside the nozzle. The sucked toner was collected by the filter, and the charge amount of the toner was measured.

The transfer current was obtained by measuring a current flowing between the transfer power source 24 and the transfer roller 62 while the transfer bias voltage was applied to the transfer roller 62. Since the transfer current and the transfer bias voltage are in a correlation, the controller controls the transfer power source to reduce the voltage applied to the transferor (that is, the transfer bias voltage) in order to reduce the transfer current.

As illustrated in FIG. 7, changing the transfer current changes the charge amount of the toner after passing through the charging position. Accordingly, adjusting the transfer current enables adjusting the charge amount of the toner after passing through the charging position.

The present inventors set the image forming apparatus to flow the transfer currents in which the charge amounts of the toner after passing through the charging position in the non-transfer period were measured, performed printing operations, and evaluated an abnormal image in the non-transfer period caused by the retransfer in each of the transfer currents that is referred to as a transfer residual ghost. The charging bias voltage Vc and the developing bias voltage Vb were set to predetermined values.

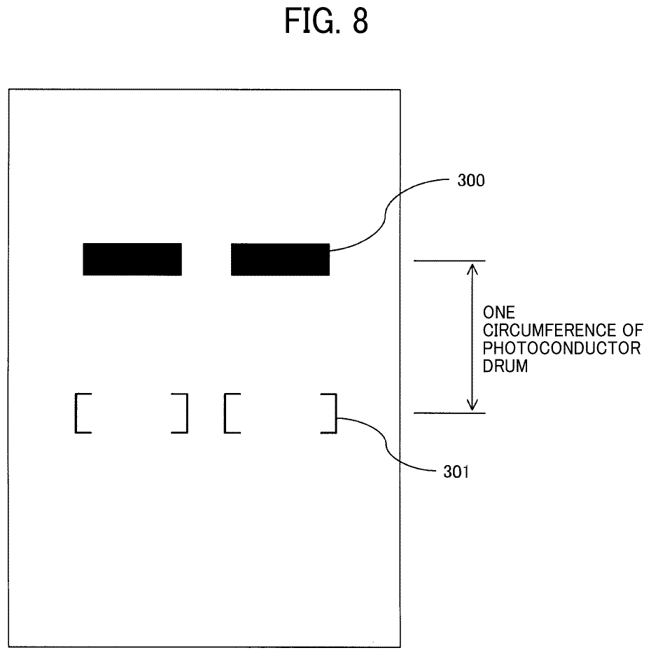

FIG. 8 is a view of an image chart used for the evaluation of retransfer. The image chart includes solid patches 300 and frames 301 each arranged to evaluate the transfer residual ghost. The image chart includes two solid patches 300 having the size of 48 mm×10 mm and arranged near the center. The image chart includes two frames 301 arranged side by side at positions separated by the length of one circumference of the photoconductor drum below the solid patches 300 to evaluate the retransfer that causes the transfer residual ghost.

The present inventors found that the graph of FIG. 7 was separated into three regions that are a first region, a second region, and a third region, corresponding to occurrence situations of the abnormal image caused by the retransfer. In the first region, the charge amount of the toner after passing through the charging position was smaller than −30 μC/g. The first region was an upper part of the graph of FIG. 7. In the second region, the charge amount of the toner after passing through the charging position was smaller than −25 μC/g and larger than −30 μC/g. The second region was the center part of the graph of FIG. 7. In the third region, the charge amount of the toner after passing through the charging position was larger than −25 μC/g. The third region was a lower part of the graph of FIG. 7.

The abnormal image caused by the retransfer occurred in the first region and the third region in the results of the experiments performed by the present inventors. In the first region, the absolute value of the charge amount of the transfer residual toner after the transfer residual toner passes through the charging position was larger than 30 μC/g, and the large charge amount of the toner increased the electrostatic adhesion force of the transfer residual toner. As a result, the retransfer occurred. In the third region, the absolute value of the charge amount of the transfer residual toner after the transfer residual toner passes through the charging position was smaller than 25 μC/g, and the small charge amount of the transfer residual toner having the typical charging polarity of the toner made it difficult for the background potential difference to move the transfer residual toner to the developing device. Thus, the retransfer occurred.

On the other hand, in the second region, the retransfer did not occur. In other words, the retransfer did not occur when the absolute value of the toner charge amount after the toner passes through the charging position was 25 μC/g to 30 μC/g. The toner charge amount in the second region prevents the electrostatic adhesion force between the transfer residual toner and the photoconductor drum 10 from becoming too large and enables the background potential difference to move the toner to the developing device. When the absolute value of the toner charge amount after the toner passes through the charging position is 25 μC/g to 30 μC/g, it can be said that the typical charge polarity of the transfer residual toner can be maintained. The results illustrated in FIG. 7 were measured under the high temperature and high humidity environment. However, the deterioration levels of toner and environments such as a low temperature and low humidity environment and an office room environment change the relationship between the charge amount of the toner after passing through the charging position and the transfer current. The present inventors studied transfer currents giving optimum charge amounts of the toner after passing through the charging position under other environments and found that controlling the transfer power source to set a value of the transfer current in the non-transfer period to zero causes the charge amount of the toner after passing through the charging position to be −30 μC/g or more and −25 μC/g or less.

The controller in the present embodiment switches the transfer current between the transfer period and the non-transfer period while maintaining the polarity of the transfer current between the transfer period and the non-transfer period in order to set the toner charge amount after the toner passes through the charging position to −30 μC/g to −25 μC/g. Alternatively, the controller in the present embodiment switches the transfer current in the non-transfer period to zero in order to set the toner charge amount after the toner passes through the charging position to −30 μC/g to −25 μC/g. In other words, the controller in the present embodiment controls the transfer power source so that the transfer current in the non-transfer period has the same polarity as the transfer current in the transfer period and has an absolute value different from an absolute value of the transfer current in the transfer period. Alternatively, the controller in the present embodiment controls the transfer power source so that the transfer current in the non-transfer period is zero.

Controlling the transfer currents in the non-transfer period and the transfer period to have the same polarity and current values with different absolute values can adjust the charge amount of the toner after the transfer and prevent abnormal charging due to the current with the opposite polarity. As a result, the charge amount of the toner after passing through the charging position is likely to be −30 μC/g to −25 μC/g. Further, controlling the transfer current in the non-transfer period to be zero decreases reduction on the charge amount of the toner before and after the transfer. As a result, the charge amount of the toner after passing through the charging position is likely to be −30 μC/g to −25 μC/g.

When the transfer current in the non-transfer period has the same polarity as the transfer current in the transfer period and has the absolute value different from the transfer current in the transfer period, the transfer currents can be appropriately selected in consideration of the purpose, and the transfer current in the non-transfer period may be smaller or larger than the transfer current in the transfer period. Preferably, the absolute value of the transfer current in the transfer period is smaller than the absolute value of the transfer current in the non-transfer period. In other words, the controller preferably controls the transfer power source so that the absolute value of the transfer current in the transfer period is smaller than the absolute value of the transfer current in the non-transfer period.

Reducing the absolute value of the transfer current in the transfer period can further reduce the retransfer. For example, the transfer current during image formation may be set to be small absolute value in order to avoid occurrence of an abnormal image such as image dust. In this case, increasing the absolute value of the transfer current in the non-transfer period can set the charge amount of the toner after passing through the charging position to an appropriate value. Reducing the absolute value of the transfer current in the transfer period enables the charge polarity of the transfer residual toner after passing through the charging position to easily maintain to be the typical polarity.

When such control is performed, the value of the transfer current can be selected as appropriate. For example, considering the graph of FIG. 7, the transfer current in the non-transfer period is preferably about 10 to 16 μA to set the charge amount of the toner after passing through the charging position to −30 μC/g to −25 μC/g in the second region of FIG. 7. In this case, the transfer current in the transfer period is preferably less than 10 μA to avoid occurrence of an abnormal image such as image dust. Since the lower limit of the transfer current flowing through an image area on the photoconductor drum and the transfer medium is the lower limit of the output of the transfer power source, the lower limit of the transfer current in the transfer period is, for example, 5 μA. The image area means an area on which the image is formed. From these, when the transfer current in the non-transfer period is about 10 to 16 μA, for example, less than 10 μA is selected as the transfer current in the transfer period, and, for example, 5 μA or more is selected.

Considering the graph of FIG. 7, the transfer current in the non-transfer period is preferably set to be 10 μA or more and 16 μA or less to set the charge amount of the toner after passing through the charging position is in the second region of FIG. 7. In other words, the controller preferably controls the transfer power source so that the transfer current in the non-transfer period is 10 μA or more and 16 μA or less. Setting the transfer current in the non-transfer period to the above-described range easily sets the charge amount of the transfer residual toner after passing through the charging position in an optimum range, and the retransfer is easily prevented.

In FIG. 7, a range in which the transfer current in the non-transfer period is 10 μA or more and 16 μA or less is indicated by a. Setting the transfer current in the non-transfer period to the range a in FIG. 7 easily sets the charge amount of the transfer residual toner after passing through the charging position to −30 μC/g to −25 μC/g.

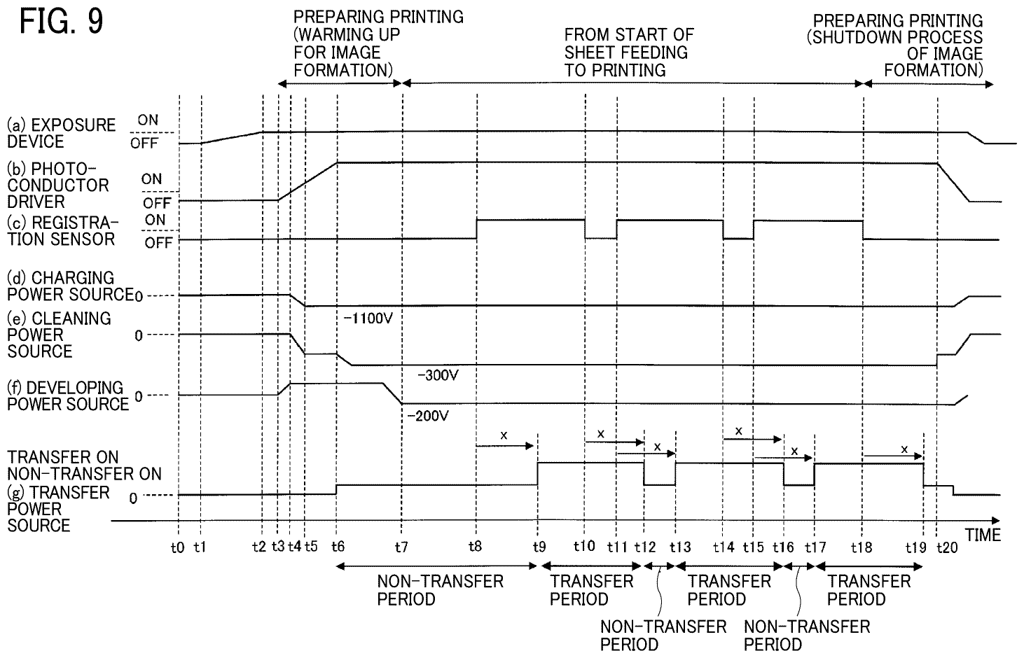

The following describes an example of a timing chart in the present embodiment. FIG. 9 is a timing chart of the image forming apparatus according to the present embodiment. In the embodiment, the image forming apparatus uses the sheet as an example of the transfer medium.

Firstly, the controller starts preparing the exposure device (a) at t1, controls a photoconductor driver (b) to start driving at t3, controls the developing power source (f) to start applying the developing bias at t3, and controls the charging power source (d) and the cleaning power source (e) to start applying the charging bias and a charging brush bias at t4. The photoconductor driver starts driving at t3 and completely stabilizes the driving at t6. At t6, warming up the photoconductor driver, the charger, and the developing device is completed.

At t6 at which the photoconductor driver stabilizes the driving, the controller turns on the transfer power source (g) to apply a non-transfer bias to the transfer roller 62. Applying the non-transfer bias to the transfer roller 62 causes the transfer current in the non-transfer period to flow the transfer roller 62. In FIG. 9, the transfer power source (g) outputs the non-transfer bias and the transfer bias. In FIG. 9, “NON-TRANSFER ON” means that the transfer power source outputs the non-transfer bias, and “TRANSFER ON” means that the transfer power source outputs the transfer bias.

The sheet is conveyed from the sheet feeder and reaches the position of the registration roller pair 6 before the transfer position, and the registration sensor (c) close to the registration roller pair 6 detects the sheet before the transfer position at t8. In other words, the registration sensor (c) outputs ON signal at t8.

At t9 at which the leading edge of the sheet enters the transfer position, the transfer power source (g) switches the second transfer current in the non-transfer period to the first transfer current in the transfer period. This control is indicated by TRANSFER ON of the transfer power source (g) at t9 in FIG. 9. The controller performs the above-described switching after a transfer switching time expressed by the following equation from t8 at which the registration sensor (c) detects the leading edge of the sheet and outputs the ON signal. A linear velocity in the following expression means a conveyance speed of the sheet.

Transfer switching time=a distance from the position of the registration sensor to the transfer position/the linear velocity

In FIG. 9, the transfer switching time is indicated by x. As illustrated FIG. 9, the transfer switching time x is from t8 to t9. At t8, the registration sensor detects the leading edge of the sheet. At t9, the leading edge of the sheet reaches the transfer position.

Transferring the toner image onto the sheet starts at t9 and completes at t12. At t10, the trailing edge of the sheet passes through the position of the registration sensor, and the registration sensor (c) stops outputting the ON signal. In other words, the detection of the registration sensor is turned off at t10. As a result, the time from t10 to t12 is the transfer switching time (x in FIG. 9).

After transferring the toner image onto the sheet completes at t12, the controller controls the transfer power source (g) to switch the first transfer current in the transfer period to the second transfer current in the non-transfer period. The controller can determine t12 that is the timing to switch the transfer current based on the detection of the registration sensor, the distance from the position of the registration sensor to the transfer position, and the linear velocity, which is the same as the above-described expression about t9. The controller controls the transfer power source to switch the transfer current after the transfer switching time from t10 at which the detection of the registration sensor is turned off.

If the image forming apparatus does not include the registration sensor, the controller can control the transfer power source to switch the transfer current based on timings to turn on and off driving the registration roller pair 6 instead of the signals from the registration sensor.

Similarly, a next toner image is transferred to the next sheet from t13 to t16, and after the next sheet, a toner image is further transferred to the sheet from t17 to t19. As a result, the period from t13 to t16 is the next transfer period, and the period from t17 to t19 is the further next transfer period. Similarly, the period from t12 to t13 is the next non-transfer period, and the period from t16 to t17 is the further next non-transfer period.

As illustrated in the above-described timing chart, the controller controls the transfer power source so that the transfer current in the non-transfer period has the same polarity as the transfer current in the transfer period and has an absolute value different from the absolute value of the transfer current in the transfer period. Controlling the transfer power source as described above sets the charge amount of the transfer residual toner after passing through the charging position to −30 μC/g or more and −25 μC/g or less. In the timing chart of FIG. 9, during the period from t12 to t13, the transfer residual toner receives the transfer current controlled as described above at the transfer position, and after the transfer residual toner passes through the charging position, the charge amount of the transfer residual toner is −30 μC/g or more and −25 μC/g or less. Setting the charge amount of the transfer residual toner after passing through the charging position in this period to the above range enhances the collection performance of the transfer residual toner by the developing device, which is the same regarding the period from t16 to t17.

In the timing chart of FIG. 9, the absolute value of the transfer current in the non-transfer period is smaller than the absolute value of the transfer current in the transfer period, but the present disclosure is not limited to this. The transfer power source may be controlled so that the absolute value of the transfer current in the transfer period is smaller than the absolute value of the transfer current in the non-transfer period, and each of them has an advantage.

The timing chart of FIG. 9 illustrates an example in which the absolute value of the transfer current in the non-transfer period is not zero, but the present disclosure is not limited to this. The transfer power source may be controlled so that the transfer current in the non-transfer period becomes zero. In this case, the charge amount of the transfer residual toner after passing through the charging position can be set to the above-described range. Controlling the transfer power source to set the transfer current in the non-transfer period to zero can more easily maintain the charge of the toner charged by the developing device than controlling the transfer power source to set the transfer current in the non-transfer period not to be zero. Whether the transfer current in the non-transfer period is set to zero may be determined in consideration of the use situation and the purpose.

In FIG. 9, a period from t3 to t7 corresponds to a period to prepare printing operations (in other words, a warming up for image formation). A period from t7 to t18 corresponds to a period from start of sheet feeding to printing the image. A period after t18 corresponds to a period to prepare a next printing operation (in other words, the shutdown process of the image formation). In the period from t7 to t18, the developing power source (f) outputs, for example, −200V as the developing bias. During this period, the developing roller 72 supplies the toner to the photoconductor drum 10 and collects the transfer residual toner from the photoconductor drum 10.

The following describes an example of control of the charger in the transfer period and the non-transfer period.

The present inventors evaluated the retransfer in the cleanerless system illustrated in FIG. 1 when the charging bias Vc that is the voltage applied to the charging roller 160 and the developing bias Vb that is the voltage applied to the developing roller 72 are changed. The image chart of FIG. 8 was used for the evaluation of the retransfer.

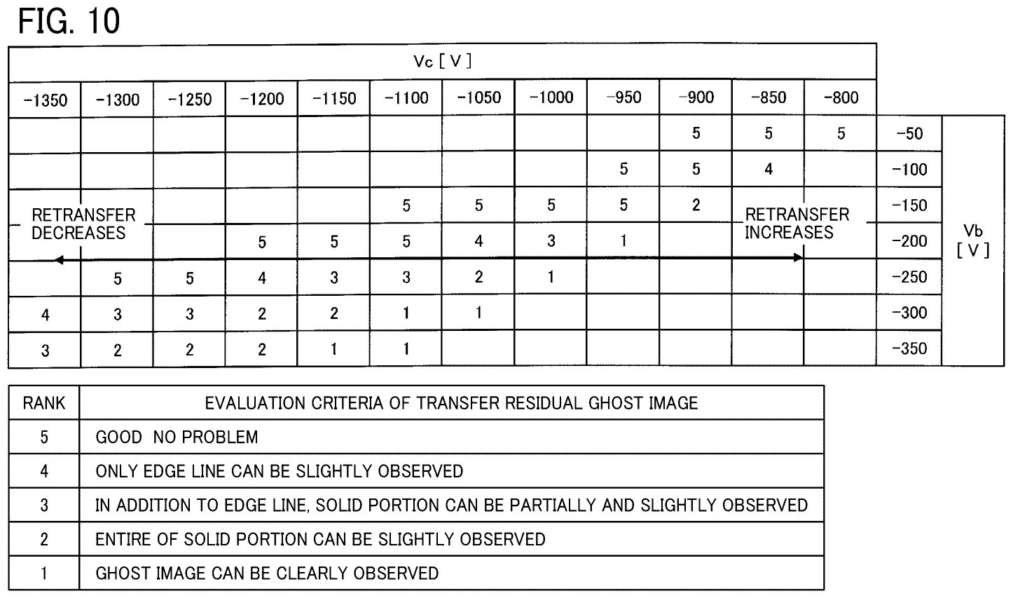

FIG. 10 is a table of evaluation results. The lateral row represents the charging bias Vc [V], and the vertical column represents the developing bias Vb [V]. In the evaluation, the transfer current was set to be constant, and the charging bias and the developing bias were changed. The present inventors set each of combinations of the charging biases and the developing biases listed in the table in the image forming apparatus and printed the image chart of FIG. 8 using the image forming apparatus. The present inventors evaluated abnormal images occurred in the sheets printed under the combinations. The abnormal images were evaluated from rank 1 to rank 5. Rank 5 means a good result and no problem. Evaluation criteria of each of rank 5 to rank 1 is described in a table in FIG. 10.

The above experimental results were obtained by using the developing device having a high developing ability, that is, the developing device capable of supplying a large amount of toner M (mg) per unit area A.

As seen from the table of FIG. 10, it is understood that the retransfer rank becomes better as the absolute value of the charging bias is increased under the same developing bias Vb. In other words, the retransfer rank tends to be better towards a left side column. This means that setting the absolute value of the charging bias Vc to be higher increases the rank of the retransfer.

Although it is difficult to generalize the configuration because it depends on the use environment and use conditions, the preferable absolute value of the charging bias is, for example, equal to or larger than −1100 when the developing bias is −200 V in the present embodiment. In this case, the occurrence of retransfer can be prevented. However, too large absolute value of the charging bias Vc excessively increases the potential difference between the charging roller and the photoconductor drum, which causes the discharge to give an excessive negative charge to the transfer residual toner. In this case, the excessive negative charge increases the electrostatic adsorption force between the transfer residual toner and the photoconductor drum, and the transfer residual toner may not be easily moved from the photoconductor drum. As a result, the transfer residual toner on the photoconductor drum is not collected by the developing device and is retransferred.

Considering the above, the amount of increase in the charging bias Vc is preferably within about 100V. The conditions corresponding the blanks in the table indicates that the discharge is slightly inferior, and the retransfer rank is slightly inferior to the acceptable level. The above-described amount of increase in the charging bias Vc means a range from the minimum absolute value of the charging bias in which the retransfer rank is 5 that is acceptable level to the value increased from the minimum absolute value by 100 V.

The controller preferably controls the charging power source to apply the charging bias having an absolute value smaller than an absolute value of the charging bias in the non-transfer period, to the charger charging a region of the photoconductor receiving the transfer current during the transfer period. The above-described control can obtain an optimum charge amount of the toner after passing through the charging position and the effect of reducing retransfer.

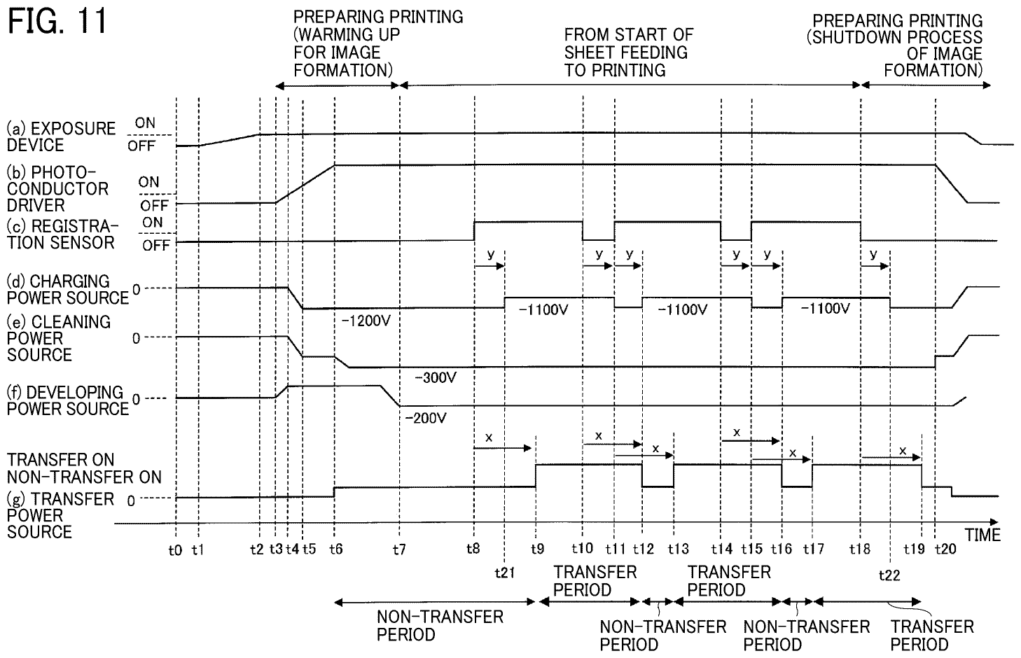

FIG. 11 is a timing chart of the above-described control. The timings from t0 to t20 are the same as the timings from t0 to t20 in FIG. 9. In FIG. 11, timings t21 and t22 are added.

In FIG. 11, the controller controls the charging power source to switch the charging bias from the charging bias voltage applied in the non-transfer period (for example, −1200 V) to the charging bias voltage having a smaller absolute value (for example, |−1100 V|) before the leading edge of the sheet reaches the transfer position. The switching of the charging bias is performed at t21, t12, and t16. The controller performs the above-described switching after a charging switching time expressed by the following equation from t8 at which the registration sensor (c) detects the leading edge of the sheet and outputs the ON signal. The linear velocity in the following expression means the conveyance speed of the sheet.

Charging switching time=(the distance from the position of the registration sensor to the transfer position−a distance from the charging position to the transfer position)/the linear velocity

In FIG. 11, the charging switching time is indicated by y. As illustrated FIG. 11, the charging switching time y is from t8 to t21. At t8, the registration sensor detects the leading edge of the sheet. The controller switches the charging bias at t21 before the leading edge of the sheet reaches the transfer position.

Subsequently, the controller controls the charging power source to switch the charging bias to the charging bias voltage applied in the non-transfer period (for example, −1200 V) at t11 before the trailing edge of the sheet passes through the transfer position. In FIG. 11, the value of the charging bias applied from t11 to t12 and from t15 to t16 is −1200 V.

As described above, the controller controls the charging power source to apply, during a part of the transfer period, the charging bias having the absolute value (for example, −1100 V) smaller than the absolute value of the charging bias in the non-transfer period (for example, −1200 V), to the charger. The above-described control can obtain an optimum charge amount of the toner after passing through the charging position and the effect of reducing retransfer.

The following describes an example of adjustment of the transfer current.

Descriptions of matters similar to the above are omitted.

The controller controls the transfer power source to adjust the transfer current so that the charge amount of the transfer residual toner after passing through the charging position is −30 μC/g or more and −25 μC/g or less. The range of the transfer current in which the charge amount of the transfer residual toner after passing through the charging position is −30 μC/g or more and −25 μC/g or less may vary depending on the use conditions. Considering the above, the controller appropriately adjusts the transfer current according to the use conditions. As a result, the charge amount of the transfer residual toner after passing through the charging position is in the above range, and the retransfer is further reduced.

The use conditions include, for example, the integrated driven amount of the developing roller, the number of sheets passing through the image forming apparatus (the integrated number of times of transfer), and the temperature and humidity environment. Adjusting the transfer current using one or more of the above use conditions can further reduce the retransfer.

The following describes an example of the adjustment using the integrated driven amount of the developing roller.

The controller preferably integrates the driven amount of the developing roller and adjusts the first transfer current in the transfer period and/or the second transfer current in the non-transfer period based on the integrated driven amount of the developing roller.

Since using the developing device over time changes the charge of the toner even under the same transfer current, the controller adjusts the transfer current using the amount of use of the developing roller. The above-described adjustment can accurately set the charge amount of the transfer residual toner after passing through the charging position to the above-described range even when the developing device is used for a long time.

The integrated driven amount of the developing roller is obtained by integrating the driven amount (for example, the amount of rotation) of the developing roller. For example, the timer 114 measures the time during which the driver 116 drives and rotates the developing roller 72 to obtain the integrated driven amount of the developing roller. The integrated driven amount of the developing roller may be referred to as the travel distance, and the unit of the integrated driven amount of the developing roller is, for example, mm. For example, the controller obtains a time from turning on driving the developing roller to turning off driving the developing roller, calculates the travel distance of the developing roller, and adds the calculated travel distance to the integrated driven amount of the developing roller stored in the controller to update the integrated driven amount of the developing roller.

An example of an expression to obtain the integrated driven amount of the developing roller is as follows. The linear velocity in the expression is the rotation speed of the developing roller 72. The unit of the linear velocity is, for example, mm/sec.

Integrated driven amount of the developing roller [mm]=Σ{(time from turning on driving the developing roller to turning off driving the developing roller)×(linear velocity)}

When the integrated driven amount of the developing roller is large, a large amount of foreign matter adheres to the developing roller 72, which increases the resistance of the developing roller 72. As a result, the potential of the developing roller tends to be large after the integrated driven amount of the developing roller is large even when the voltage applied to the developing roller 72 is the same. Therefore, the large integrated driven amount of the developing roller after the developing device is used for a long time tends to decrease the background potential difference.

To prevent the decrease in the background potential difference caused by the large integrated driven amount of the developing roller, the controller performs control to increase the surface potential Vd on the photoconductor drum 10, that is, the controller controls the transfer power source to reduce the transfer current, which reduces the amount of charge removed from the photoconductor drum 10 by the transfer roller 62. In short, the controller controls the transfer power source to reduce the transfer current when the integrated driven amount of the driving roller is large.

A supplementary explanation is provided regarding the adjustment of the transfer current in the transfer period and/or the transfer current in the non-transfer period.

When the controller adjusts the transfer current in the transfer period and/or the transfer current in the non-transfer period, the controller may adjust both of the transfer currents or one of the transfer currents. For example, the controller adjusts both transfer currents when an environmental change occurs or when the transfer member is deteriorated. In this case, the controller adjusts the transfer currents in the transfer period and the non-transfer period by the same tendency. For example, when the controller increases the transfer current in the transfer period, the controller also increases the transfer current in the non-transfer period.

The controller adjusts one of the transfer currents to avoid the occurrence of the abnormal image due to the retransfer and another abnormal image or to change the ratio of the allowance of the abnormal image.

Since the toner image is transferred to the transfer medium in the transfer period, the transfer current in the transfer period is preferably determined considering the basic image quality not to cause the retransfer. Since the toner image is not transferred to the transfer medium in the non-transfer period, the second transfer current in the non-transfer period is preferably determined considering not to cause the retransfer without considering the image quality.

The above supplementary explanation is also applied to the number of times of transfer and the absolute humidity described below.

The following describes an example of the adjustment using the number of sheets passing through the image forming apparatus (the integrated number of times of transfer).

The controller preferably adjusts the first transfer current in the transfer period and/or the second transfer current in the non-transfer period based on the integrated number of times of transfer obtained by integrating the number of times of transfer.

When using the image forming apparatus for a long time increases the integrated number of times of transfer, the amount of foreign matter adhering to the transfer roller 62 increase, which increases the resistance of the transfer roller 62. In order to maintain a transfer voltage to be constant, the controller controls the transfer power source to reduce the transfer current (V=IR). The above-described adjustment can accurately set the charge amount of the transfer residual toner after passing through the charging position to the above-described range even when the image forming apparatus is used for a long time. Since the transfer current and the transfer bias voltage are in a correlation, the controller controls the transfer power source to reduce the transfer current when the integrated number of times of transfer increases.

An example of an expression to obtain the integrated number of times of transfer is as follows.

Integrated number of times of transfer=Σ(number of times of transfer)

The controller 25 can count the integrated number of times of transfer. The transfer may be performed on the recording medium such as the sheet or on the intermediate transferor such as the intermediate transfer belt. The number of times of transfer means the number of times of transfer to the transfer medium. The integrated number of times of transfer may be calculated for each transfer or for each job. When the controller adjusts the transfer current for each transfer, the controller calculates the integrated number of times of transfer for each transfer. When the controller adjusts the transfer current for each job, the controller calculates the integrated number of times of transfer for each job. When the integrated number of times of transfer is calculated for each job, the above expression may be considered as the following expression.

Integrated number of times of transfer=Σ(number of times of transfer in the job)

The following describes an example of the adjustment using the temperature and humidity environment.

The controller preferably adjusts the first transfer current in the transfer period and/or the second transfer current in the non-transfer period based on the temperature and humidity environment inside or outside the image forming apparatus.

Since the charge of the toner changes even for the same transfer current depending on the temperature and humidity environment, controlling the transfer current based on the temperature and humidity environment can accurately set the charge amount of the transfer residual toner after passing through the charging position to the above-described range without being affected by the change in the temperature and humidity environment.

It is preferable to adjust the transfer current by using some of the integrated driven amount of the developing roller, the integrated number of times of transfer, and the temperature and the absolute humidity (that is the temperature and humidity environment). An example of this case is described below.

The controller preferably adjusts the first transfer current in the transfer period and/or the second transfer current in the non-transfer period based on two or more selected from the integrated driven amount of the developing roller obtained by integrating the driven amount of the developing roller, the integrated number of times of transfer obtained by integrating the number of times of transfer, and the temperature and the absolute humidity inside or outside the image forming apparatus. In this case, the charge amount of the transfer residual toner after passing through the charging position can be accurately set to the above-described range. The temperature and the absolute humidity are considered as one condition as the temperature and humidity environment and are preferably handled in the same manner as the integrated driven amount of the developing roller and the integrated number of times of transfer.

The controller can calculate the temperature and the absolute humidity inside or outside the image forming apparatus using, for example, the sensor 115. The temperature and the humidity may be obtained by other sensors. The temperature and the absolute humidity may be referred to as the temperature and humidity environment.

The transfer current may be determined using correction values. For example, when the controller adjusts the transfer current using some of the integrated driven amount of the developing roller, the integrated number of times of transfer, and the temperature and the absolute humidity, the controller may determine the transfer current using one of these and may perform adjustment for correcting the transfer current using the remaining. The transfer current determined using one of these values is also referred to as a transfer current value, and the value used to correct the transfer current is also referred to as a transfer current correction value. Performing the above-described control can accurately set the charge amount of the transfer residual toner after passing through the charging position to the above-described range.

In particular, it is more preferable to adjust the transfer current by using the integrated number of times of transfer and the temperature and humidity environment. An example of control using the integrated number of times of transfer and the absolute humidity is described below.

The controller selects the first transfer current in the transfer period and/or the second transfer current in the non-transfer period based on the temperature and the absolute humidity inside or outside the image forming apparatus and adjusts the selected transfer current based on the transfer current correction value selected based on the integrated number of times of transfer obtained by integrating the number of times of transfer.

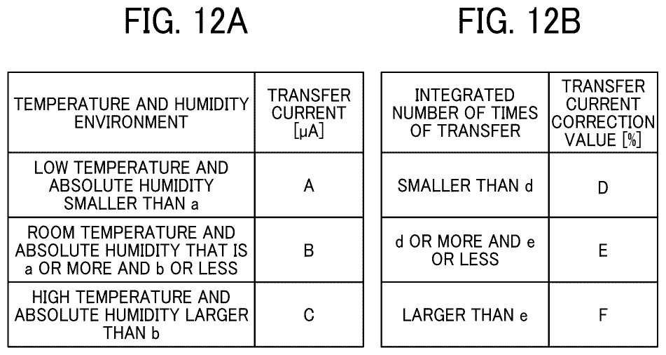

Performing the above-described control can accurately set the charge amount of the transfer residual toner after passing through the charging position to the above-described range. An example of this control is described below with reference to FIG. 12.

Preferably, the higher the temperature and the absolute humidity, the higher the transfer current is set by the controller, and the larger the integrated number of times of transfer, the larger the transfer current correction value is set by the controller.

Performing the above-described control can accurately set the charge amount of the transfer residual toner after passing through the charging position to the above-described range. An example of this control is described below with reference to FIG. 12.

The transfer current values and the transfer current correction values may be stored in advance in the storage unit or the memory as tables. The integrated driven amount of the developing roller, the integrated number of times of transfer, and the temperature and humidity environment are measured, and the controller may use the measured values and refer to the tables to adjust the transfer current.

FIGS. 12A and 12B are examples of the tables used to determine the transfer current. These tables are determined in advance and stored in any desired storage or memory. FIG. 12A is a table including transfer currents corresponding to temperature and humidity environment conditions (that are temperatures and absolute humidities) divided into three sections. FIG. 12B is a table including transfer current correction values corresponding to the integrated numbers of times of transfer divided into three sections. The unit of the integrated number of times of transfer is, for example, times or sheets. The way of dividing the sections is not limited.

For example, as in the present example, the temperature and humidity environment is divided into three sections, and the controller determines which section the temperature and the absolute humidity measured by the sensor correspond to and sets the transfer current of the corresponding section. For example, when the temperature is low and the absolute humidity is less than a, the controller sets A [μ A] as the transfer current. Similarly, the controller sets the transfer current corresponding to the room temperature or the high temperature. The range of the low temperature, the room temperature, and the high temperature can be selected as appropriate. FIG. 12A is the table including transfer currents corresponding temperature and humidity environment conditions, but the present disclosure is not limited to this. A table may be set so as to include transfer currents corresponding to the integrated numbers of times of transfer or the integrated driven amounts of the developing roller.

FIG. 12B is the table including transfer current correction values. For example, when the integrated number of times of transfer is less than d, the controller sets D [%] as the transfer current correction value. The transfer current correction value is applied to, for example, the transfer current in the table of FIG. 12A.

For example, under the condition including the low temperature, the absolute humidity less than a, and the integrated number of transfers less than d, the controller selects A[μ A] as the transfer current value and D [%] as the transfer current correction value. In this case, the controller adjusts the transfer current to be A[μ A]×D [%].

In addition, for example, under the condition including the room temperature, the absolute humidity that is a or more and b or less, and the integrated number of transfers larger than e, the controller selects B[μ A] as the transfer current value and F[%] as the transfer current correction value. In this case, the controller adjusts the transfer current to be B[μ A]×F [%].

In addition, preferably, A, B, and C in the table of FIG. 12A are set to be higher values in this order. As the temperature increases, the controller preferably adjusts the transfer current to be larger. As the absolute humidity increases, the controller preferably adjusts the transfer current to be larger. In addition, the controller may adjust the transfer current to be larger as the integrated number of times of transfer or the integrated driven amount of the developing roller increases.

In addition, preferably, D, E, and F in the table of FIG. 12B are set to be higher values in this order. The larger the integrated number of times of transfer is, the larger the transfer current correction value is preferably set. For example, D=100%, E=105%, and F=110%.

As described above, using the predetermined table enables adjusting the transfer current in accordance with the use over time and the temperature and humidity environment, optimizing the charge amount of the transfer residual toner after passing through the charging position, and further reducing the retransfer.

The tables illustrated in FIGS. 12A and 12B are defined for each of the transfer period and the non-transfer period. The table for the transfer period and the table for the non-transfer period may be the same or different.

Another example is described below.

Descriptions of matters similar to the above are omitted.

The image forming apparatus includes a peeling roller. The peeling roller reduces the adhesion force of the toner strongly adhering (in other words, firmly fixed) to the photoconductor. Reducing the adhesion force of the toner can enhance collection performance of the transfer residual toner by the developing device. In addition, the peeling roller can reduce filming on the photoconductor.

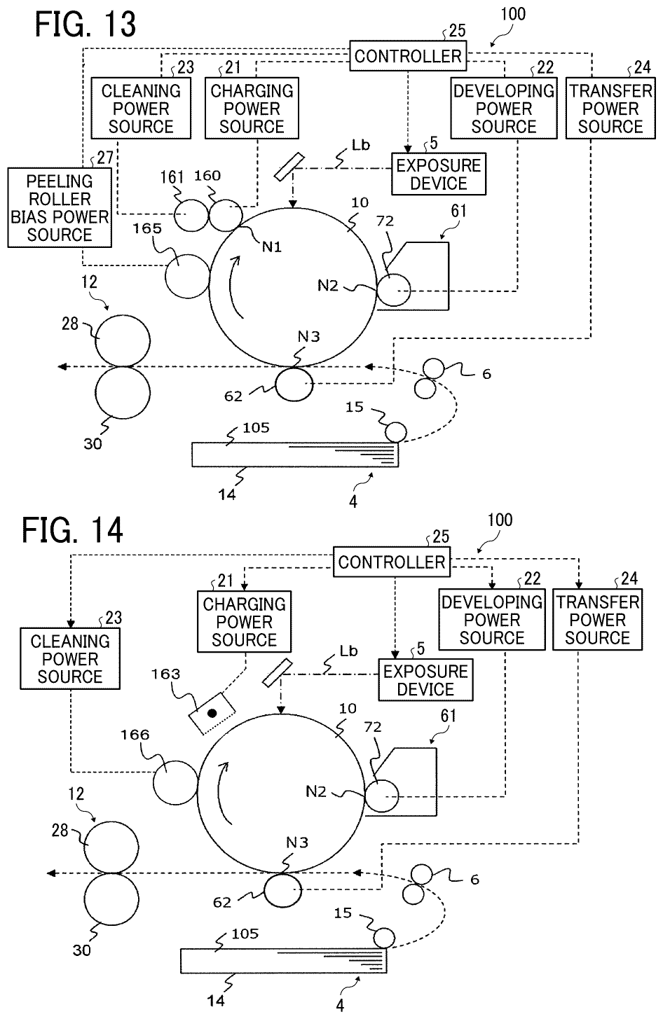

FIG. 13 is another schematic diagram of the image forming apparatus similar to FIG. 1. A peeling roller 165 is disposed in contact with the photoconductor drum 10. The peeling roller 165 is disposed downstream of the transfer roller 62 and upstream of the charging roller 160 in the rotation direction of the photoconductor drum 10.

The peeling roller 165 is made of, for example, a sponge of silicone resin.

The image forming apparatus may not include the discharge lamp 64 as the discharger. The image forming apparatus in FIG. 13 does not include the discharge lamp.

The peeling roller 165 rotates with a peripheral speed different from the photoconductor drum 10, and the peripheral speed difference enables the peeling roller 165 to remove the transfer residual toner from the photoconductor drum 10. The peeling roller 165 rubs the surface of the photoconductor drum 10 to remove the transfer residual toner from the surface of the photoconductor drum 10.

The image forming apparatus 100 in FIG. 13 includes a peeling roller bias power source 27 to apply a negative voltage to the peeling roller 165. The absolute value of the negative voltage applied to the peeling roller 165 is preferably smaller than the absolute value of the voltage applied to the charging roller 160 to charge the transfer residual toner to be −30 μC/g or more and −25 μC/g or less after the toner passes through the charging position.

The peeling roller 165 applied the voltage as described above moves and charges the transfer residual toner, and the charged transfer residual toner adheres to the surface of the photoconductor drum 10 again. The charging roller 160 causes the pre-charging discharge that negatively charges the transfer residual toner, and the developing roller 72 collects the transfer residual toner negatively charged. Since the transfer residual toner removed from the photoconductor drum 10 by the peeling roller 165 adheres again to the photoconductor drum 10 with a weak adhesion force, the transfer residual toner is easily collected by the developing roller 72. As a result, filming on the photoconductor drum 10 can be reduced.

As described above, the peeling roller 165 reduces the adhesion force of the toner strongly adhering (in other words, firmly fixed) to the photoconductor drum 10. The peeling roller 165 can reduce the adhesion force between the transfer residual toner and the surface of the photoconductor drum 10, which enables the developing roller 72 to easily collect the transfer residual toner.

The present embodiment is described again.

The image forming apparatus in the present embodiment includes the peeling roller downstream of a position at which the transferor transfers the image onto the transfer medium and upstream of the charging position in the rotation direction of the image bearer. The peeling roller rotates in contact with the image bearer, and the peripheral speed difference between the peeling roller and the image bearer removes the transfer residual toner adhering to the surface of the image bearer from the surface of the image bearer.

Arranging the peeling roller as described above can reduce the adhesion force of the transfer residual toner before the pre-charging discharge, and utilizing the peripheral speed difference can easily remove the transfer residual toner from the image bearer.

Preferably, the absolute value of the voltage applied to the peeling roller is smaller than the absolute value of the voltage applied to the charger. In this case, the adhesion force of the transfer residual toner adhering to the photoconductor drum 10 again can be reduced.

Yet another example is described below. Descriptions of matters similar to the above are omitted.

The image forming apparatus in the present embodiment includes a non-contact type charger and a temporary cleaning roller disposed on the photoconductor drum. Since the cleanerless system is defined as a system in which the developing roller collects the toner, the system including the temporary cleaning roller in addition to the developing roller that collects the toner is included in the cleanerless system.

FIG. 14 is a schematic diagram of the image forming apparatus according to the present embodiment and is similar to FIG. 1. The image forming apparatus in this example includes a scorotron charger as a charger 163 in FIG. 14. As illustrated in FIG. 14, the charger 163 is a non-contact type charger.

In addition, the image forming apparatus includes a temporary cleaning roller 166 downstream of the transfer roller 62 and upstream of the charger 163 in the rotation direction of the photoconductor drum 10. The temporary cleaning roller 166 is, for example, a brush roller.

The cleaning power source 23 applies a voltage, for example, a negative voltage to the temporary cleaning roller 166. In this case, the temporary cleaning roller 166 temporarily stores the transfer residual toner positively charged. The above description means that the transfer residual toner positively charged moves to the temporary cleaning roller 166 and is held by the temporary cleaning roller 166. The transfer residual toner temporarily stored in the temporary cleaning roller 166 has a charge polarity opposite the typical charging polarity of the toner. The typical charging polarity of the toner in this example is negative, and the toner having the charge polarity opposite the typical charging polarity is the transfer residual toner charged to the positive polarity as described above.

On the other hand, the transfer residual toner having the negative polarity passes through the temporary cleaning roller 166, the pre-charging discharge caused by the charging roller 160 injects negative charges into the transfer residual toner, and the developing roller 72 collects the transfer residual toner.

In this example, a positive voltage is applied to the temporary cleaning roller 166 while a job is completed. As a result, the potential difference between the temporary cleaning roller 166 and the photoconductor drum 10 moves the transfer residual toner having the positive polarity and stored in the temporary cleaning roller 166 to the photoconductor drum 10. This movement is also referred to as discharge. The pre-charging discharge caused by the charger 163 injects negative charges into the moved transfer residual toner, and the developing roller 72 collects the transfer residual toner. As a result, the temporary cleaning roller 166 can be kept clean.

In this example, the temporary cleaning roller 166 is disposed upstream of the charger 163 in the rotation direction of the photoconductor drum 10. Therefore, immediately after the transfer residual toner is moved from the temporary cleaning roller 166 to the photoconductor drum 10, the charger 163 injects the negative charge into the transfer residual toner. Since the pre-charging discharge injects the negative charges into the transfer residual toner immediately after the transfer residual toner moves from the temporary cleaning roller 166 to the photoconductor drum 10, a distance for rotating the photoconductor drum 10 until the pre-charging discharge injects the negative charges into the transfer residual toner can be shortened.

The distance for rotating the photoconductor drum 10 until the pre-charging discharge injects the negative charges into the transfer residual toner in this example can be shorter than that in the above-described embodiment using the collection brush 161. Accordingly, the deterioration of the photoconductor drum 10 can be delayed, and the life of the photoconductor drum 10 can be extended.

In the embodiment using the collection brush 161, the transfer residual toner held by the collection brush 161 is moved from the collection brush 161 to the charging roller 160, and then passes through the positions of the developing roller 72 and the transfer roller 62, and the pre-charging discharge charges the transfer residual toner. Therefore, the distance for rotating photoconductor drum 10 until the transfer residual toner stored in the temporary cleaning roller 166 moves to the photoconductor drum 10 and receives the charge of the pre-charging discharge in this example can be shorter than the distance for rotating photoconductor drum 10 until the transfer residual toner stored in the collection brush 161 moves to the photoconductor drum 10 and receives the charge of the pre-charging discharge.

The above example is described again.

The image forming apparatus includes the non-contact type charger not in contact with the image bearer as the charger. The image forming apparatus includes the temporary collector downstream of the position at which the transferor transfers the image onto the transfer medium and upstream of the charging position in the rotation direction of the image bearer. The temporary collector temporarily collects the transfer residual toner that is charged to the polarity opposite the typical charging polarity of the toner (for example, positive) and is on the surface of the image bearer.

The temporary collector is, for example, the temporary cleaning roller 166.

Using the non-contact type charger as the charger can prevent the transfer residual toner from moving to the charger and causing charging failure. Using the temporary collector arranged as described above can move the transfer residual toner from the image bearer to the temporary collector and temporarily store the transfer residual toner in the temporary collector.

The image forming apparatus includes a cleaning power source such as the cleaning power source 23 applying the voltage to the temporary collector. The controller controls the cleaning power source to move the transfer residual toner collected by the temporary collector to the image bearer while image formation is completed.

In the above-described configuration, the pre-charging discharge can charge the transfer residual toner immediately after the transfer residual toner collected by the temporary collector is discharged to the image bearer, and the distance for rotating the image bearer can be reduced. As a result, the life of the image bearer can be extended. In addition, moving the transfer residual toner collected by the temporary collector to the image bearer can keep the temporary collector clean over time.

Aspects of the present disclosure are, for example, as follows.

### <First Aspect>

In a first aspect, an image forming apparatus includes a rotatable image bearer, a charger to charge the image bearer, a developing device including a developing roller to supply toner to the image bearer and form a toner image on the image bearer, a transferor to transfer the toner image to a transfer medium, a transfer power source to apply a voltage to the transferor, and a controller that is circuitry. In the image forming apparatus, the developing device collects transfer residual toner remaining on the image bearer after the transferor transfers the toner image to the transfer medium. A charging position is defined as a position at which the charger faces the image bearer. A developing position is defined as a position at which the developing roller faces the image bearer. A transfer current is defined as a current flowing through the transferor. A transfer period is defined as a period in which the transferor transfers the toner image to the transfer medium. A non-transfer period is defined as a period in which the transferor does not transfer the toner image to the transfer medium. The controller controls the transfer power source so that the transfer current in the non-transfer period is zero or a current value having the same polarity as a transfer current in the transfer period and an absolute value different from an absolute value of the transfer current in the transfer period. The controller controls the transfer power source so that a charge amount of the transfer residual toner on the image bearer downstream of the charging position and upstream of the developing position in a rotation direction of the image bearer is −30 μC/g or more and −25 μC/g or less.

### <Second Aspect>

In a second aspect, the controller in the image forming apparatus according to the first aspect is further configured to integrate a driven amount of the developing roller to obtain an integrated driven amount of the developing roller and adjust the transfer current in the transfer period and/or the transfer current in the non-transfer period based on the integrated driven amount of the developing roller.

### <Third Aspect>

In a third aspect, the controller in the image forming apparatus according to the first aspect or the second aspect is further configured to adjust the transfer current in the transfer period and/or the transfer current in the non-transfer period based on an integrated number of times of transfer obtained by integrating the number of times of transfer.

### <Fourth Aspect>

In a fourth aspect, the controller in the image forming apparatus according to any one of the first to third aspects is further configured to adjust the transfer current in the transfer period and/or the transfer current in the non-transfer period based on a temperature and an absolute humidity inside or outside the image forming apparatus.

### <Fifth Aspect>

In a fifth aspect, the controller in the image forming apparatus according to any one of the first to fourth aspects is further configured to adjust the transfer current in the transfer period and/or the transfer current in the non-transfer period based on two or more selected from an integrated driven amount of the developing roller obtained by integrating a driven amount of the developing roller, an integrated number of times of transfer obtained by integrating the number of times of transfer, and a temperature and an absolute humidity inside or outside the image forming apparatus.

### <Sixth Aspect>

In a sixth aspect, the controller in the image forming apparatus according to any one of the first to fifth aspects is further configured to select the transfer current in the transfer period and/or the transfer current in the non-transfer period based on a temperature and an absolute humidity inside or outside the image forming apparatus and adjust the selected transfer current based on a current correction value selected based on an integrated number of times of transfer obtained by integrating the number of times of transfer.

### <Seventh Aspect>

In a seventh aspect, the controller in the image forming apparatus according to the sixth aspect is further configured to increase a value of the selected transfer current as the temperature and the absolute humidity increases and increase the current correction value as the integrated number of times of transfer increases.

### <Eighth Aspect>

In an eighth aspect, the controller in the image forming apparatus according to any one of the first to seventh aspects is further configured to control the transfer power source so that an absolute value of the transfer current in a transfer period is smaller than an absolute value of the transfer current in the non-transfer period.

### <Ninth Aspect>

In a ninth aspect, the controller in the image forming apparatus according to any one of the first to eighth aspects is further configured to control a charging power source to apply a voltage to the charger so that an absolute value of the voltage applied to the charger in a part of the transfer period is smaller than an absolute value of the voltage applied to the charger in the non-transfer period.

### <Tenth Aspect>

In a tenth aspect, the controller in the image forming apparatus according to any one of the first to ninth aspects is further configured to control the transfer power source so that the transfer current in the non-transfer period is 10 μA or more and 16 μA or less.

### <Eleventh Aspect>

In an eleventh aspect, the charger in the image forming apparatus according to any one of the first to tenth aspects is disposed so as to be in contact with the image bearer.

### <Twelfth Aspect>

In a twelfth aspect, the image forming apparatus according to any one of the first to eleventh aspects further includes a peeling roller contacting the image bearer downstream of a position at which the transferor performs transfer and upstream of the charging position and rotating such that a peripheral speed difference between the peeling roller and the image bearer peels off transfer residual toner adhering to the surface of the image bearer.

### <Thirteenth Aspect>

In a thirteenth aspect, the peeling roller in the image forming apparatus according to the twelfth aspect is applied with a voltage having an absolute value smaller than an absolute value of a voltage applied to the charger.

### <Fourteenth Aspect>

In a fourteenth aspect, the image forming apparatus according to any one of the first to thirteenth aspects further includes a temporary collector disposed downstream of a position at which the transferor performs transfer and upstream of the charging position in a rotation direction of the image bearer to temporary collect transfer residual toner charged to a polarity opposite to a typical charging polarity of transfer residual toner on the surface of the image bearer, and the charger is a non-contact type charger that does not contact the image bearer.

### <Fifteenth Aspect>

In a fifteenth aspect, the image forming apparatus according to the fourteenth aspect further includes a cleaning power source to apply a voltage to the temporary collector, and the controller controls the cleaning power source to move the transfer residual toner collected by the temporary collector to the image bearer when an image formation is completed.

### <Sixteenth Aspect>

In a sixteenth aspect, a toner collection method is performed by an image forming apparatus including a rotatable image bearer, a charger to charge the image bearer, a developing device including a developing roller to supply toner to the image bearer and form a toner image on the image bearer, a transferor to transfer the toner image to a transfer medium, a transfer power source to apply a voltage to the transferor, and a controller. In the collection method, the developing device collects transfer residual toner remaining on the image bearer after the transferor transfers the toner image. The toner collection method includes a control process. A charging position is defined as a position at which the charger faces the image bearer. A developing position is defined as a position at which the developing roller faces the image bearer. A transfer current is defined as a current flowing through the transferor. A transfer period is defined as a period in which the transferor transfers the toner image to the transfer medium. A non-transfer period is defined as a period in which the transferor does not transfer the toner image to the transfer medium. In the control process, the controller controls the transfer power source so that the transfer current in the non-transfer period is zero or a current value having the same polarity as a transfer current in the transfer period and an absolute value different from an absolute value of the transfer current in the transfer period. In the control process, the controller controls the transfer power source so that a charge amount of the transfer residual toner on the image bearer downstream of the charging position and upstream of the developing position in a rotation direction of the image bearer is −30 μC/g or more and −25 μC/g or less.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

1. An image forming apparatus comprising:
an image bearer rotatable in a rotation direction;
a charger facing the image bearer at a charging position, the charger to charge the image bearer at the charging position;
a developing device including a developing roller, the developing roller facing the image bearer at a developing position to:
supply toner to the image bearer; and
form a toner image on the image bearer with the toner at the developing position;
a transferor to transfer the toner image onto a transfer medium in a transfer period;
a transfer power source to apply voltages to the transferor to:
flow a first transfer current to the transferor during the transfer period; and
flow a second transfer current different from the first transfer current to the transferor during a non-transfer period when the transferor does not transfer the toner image to the transfer medium; and
circuitry configured to:
control the transfer power source to:
set a value of the second transfer current to at least one of:
zero; or
a value having:
the same polarity as the first transfer current; and
an absolute value different from an absolute value of the first transfer current; and
control a charge amount of a transfer residual toner during the non-transfer period, remaining on the image bearer downstream of the charging position and upstream of the developing position in the rotation direction after the toner is transferred to the transfer medium, to be −30 μC/g or more and −25 μC/g or less.

2. The image forming apparatus according to claim 1,
wherein the circuitry is further configured to:
calculate an integration of a driven amount of the developing roller to obtain an integrated driven amount of the developing roller; and
adjust at least one of the first transfer current or the second transfer current based on the integrated driven amount.

3. The image forming apparatus according to claim 1,
wherein the circuitry is further configured to:
calculate an integration of a number of times of a transfer operation performed by the transferor to obtain an integrated number of times of transfer operation; and
adjust at least one of the first transfer current or the second transfer current based on the integrated number of times of transfer operation.

4. The image forming apparatus according to claim 1,
wherein the circuitry is further configured to:
adjust at least one of the first transfer current or the second transfer current based on:
a temperature; and
an absolute humidity,
inside or outside the image forming apparatus.

5. The image forming apparatus according to claim 1,
wherein the circuitry is further configured to:
calculate an integration of a driven amount of the developing roller to obtain an integrated driven amount of the developing roller;
calculate an integration of a number of times of a transfer operation performed by the transferor to obtain an integrated number of times of transfer operation; and
adjust at least one of the first transfer current or the second transfer current based on two or more of:
the integrated driven amount of the developing roller;
the integrated number of times of transfer operation; and
a temperature and an absolute humidity inside or outside the image forming apparatus.

6. The image forming apparatus according to claim 1,
wherein the circuitry is configured to:
calculate an integration of a number of times of a transfer operation performed by the transferor to obtain an integrated number of times of transfer operation
and has:
a first table including current values of at least one of the first transfer current or the second transfer current corresponding to temperatures and absolute humidities inside or outside the image forming apparatus; and
a second table including current correction values corresponding to integrated numbers of times of transfer operations, and
further configured to:
select one current value of at least one of the first transfer current or the second transfer current from the first table based on a temperature and an absolute humidity inside or outside the image forming apparatus;
select one current correction value from the second table based on the calculated integrated number of times of the transfer operation; and
adjust at least one of the first transfer current or the second transfer current using the selected current value and the selected current correction value.

7. The image forming apparatus according to claim 6,
wherein the current value increases as the temperature and the absolute humidity increase in the first table, and
the current correction value increases as the integrated number of times of the transfer operation increases in the second table.

8. The image forming apparatus according to claim 1,
wherein an absolute value of the first transfer current is smaller than an absolute value of the second transfer current.

9. The image forming apparatus according to claim 1, further comprising
a charging power source to apply a voltage to the charger,
wherein the circuitry is further configured to control the charging power source to apply, to the charger during a part of the transfer period, a voltage having an absolute value smaller than an absolute value of a voltage applied to the charger in the non-transfer period.

10. The image forming apparatus according to claim 1,
wherein the second transfer current is 10 μA or more and 16 μA or less.

11. The image forming apparatus according to claim 1,
wherein the charger is disposed in contact with the image bearer.

12. The image forming apparatus according to claim 1, further comprising
a peeling roller rotatably contacting the image bearer upstream of the charging position and downstream of a position at which the transferor transfers the toner image to the transfer medium in a rotation direction of the image bearer such that a peripheral speed difference between the peeling roller and the image bearer removes transfer residual toner adhering to a surface of the image bearer from the surface of the image bearer.

13. The image forming apparatus according to claim 12, further comprising
a power source to apply a voltage to the peeling roller, the voltage having an absolute value smaller than an absolute value of a voltage applied to the charger.

14. The image forming apparatus according to claim 1, further comprising:
a temporary collector on the image bearer downstream of a position at which the transferor transfers the image onto the transfer medium and upstream of the charging position in the rotation direction of the image bearer; and
a cleaning power source to apply a voltage of a typical charging polarity of the toner to the temporary collector such that the temporary collector temporarily collects transfer residual toner charged to a polarity opposite to the typical charging polarity of the toner on a surface of the image bearer.

15. The image forming apparatus according to claim 14,
wherein the circuitry is further configured to control the cleaning power source to apply a voltage of the polarity opposite to the typical charging polarity of the toner to the temporary collector such that the toner collected by the temporary collector moves to the image bearer.
